(19) United States
(12) Patent Application Publication
(10) Pub. No.: US 2011/0152082 A1
(43) Pub. Date: Jun. 23, 2011

(54) LIQUID FORMULATIONS

(75) Inventors: Frank SIXL, Rechtsupweg (DE); Udo Bickers, Kelkheim (DE); Harry Koppert, Idstein (DE)

(73) Assignee: BAYER CROPSCIENCE AG, Monheim (DE)

(21) Appl. No.: 12/974,073

(22) Filed: Dec. 21, 2010

Related U.S. Application Data
(60) Provisional application No. 61/290,389, filed on Dec. 28, 2009.

(30) Foreign Application Priority Data
Dec. 23, 2009 (EP) 09015989.8

(51) Int. Cl. A01N 47/36; A01N 25/32; A01P 13/02; A01P 13/00; A01P 7/04; A01P 3/00; A01P 21/00

(52) U.S. Cl. 504/101; 504/212; 504/103; 504/133; 504/105; 504/107; 504/112

(57) ABSTRACT

The present invention relates to a liquid formulation comprising
a) agrochemically active salts of 2-iodo-N-[(4-methoxy-6-methyl-1,3,5-triazin-2-yl)carbamoyl]benzenesulfonamide, and
b) one or more non-polar organic solvents selected from the group of the C₆-C₁₆-aromatics mixture
   the Solvesso series (Exxon) and/or
   the Caromax series (Carless), and also
optionally further non-polar organic solvents.

The liquid formulation is suitable for crop protection.

### CROSS REFERENCE TO RELATED APPLICATIONS

This application claims priority from EP 09015989.8 filed Dec. 23, 2009 and U.S. Provisional Application No. 61/290,389 filed Dec. 28, 2009, the contents of which are incorporated herein by reference in their entireties.

### BACKGROUND OF THE INVENTION

### Field of the Invention

The present invention relates to the field of formulations of crop protection agents.

### SUMMARY OF THE INVENTION

In particular, the invention relates to liquid formulations each comprising the agrochemically active salts of the active compound of the formula (I), i.e. 2-iodo-N-[(4-methoxy-6-methyl-1,3,5-triazin-2-yl)carbamoyl]benzenesulfonamide,

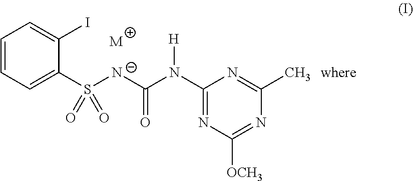

M⁺ in active compounds of the formula (I) is
   (i) an alkali metal ion, preferably lithium, sodium, potassium, or
   (ii) an alkaline earth metal ion, preferably calcium or magnesium, or
   (iii) a transition metal ion, preferably manganese, copper, zinc or iron, or
   (iv) an ammonium ion where optionally one, two or three or all four hydrogen atoms are substituted by identical or different radicals from the group consisting of (C₁-C₄)-alkyl, hydroxy-(C₁-C₄)-alkyl, (C₃-C₆)-cycloalkyl, (C₁-C₄)-alkoxy-(C₁-C₄)-alkyl, hydroxy-(C₁-C₄)-alkoxy-(C₁-C₄)-alkyl, (C₁-C₆)-mercaptoalkyl, phenyl and benzyl, where the radicals mentioned above are optionally substituted by one or more identical or different radicals from the group consisting of halogen, such as F, Cl, Br or I, nitro, cyano, azido, (C₁-C₆)-alkyl, (C₁-C₆)-haloalkyl, (C₃-C₆)-cycloalkyl, (C₁-C₆)-alkoxy, (C₁-C₆)-haloalkoxy and phenyl and where in each case two substituents at the nitrogen atom together optionally form an unsubstituted or substituted ring, or
   (v) a phosphonium ion, or
   (vi) a sulfonium ion, preferably tri-((C₁-C₄)-alkyl)sulfonium, or
   (vii) an oxonium ion, preferably tri-((C₁-C₄)-alkyl)oxonium, or
   (viii) a saturated or unsaturated/aromatic nitrogenous heterocyclic ionic compound which has 1-10 carbon atoms in the ring system and is optionally mono- or polycondensed and/or substituted by (C₁-C₄)-alkyl in a non-polar organic solvent or a mixture of non-polar organic solvents.

### DETAILED DESCRIPTION OF A PREFERRED EMBODIMENT

The liquid formulation can be present in the form of emulsion concentrates (EC) or, if the active compound of the formula (I) is not completely dissolved, as oil dispersions (OD).

In general, active compounds for crop protection are not employed in pure form. Depending on the area of use and the type of use, and on physical, chemical and biological parameters, the active compound is used as an active compound formulation in a mixture with customary auxiliaries and additives. Also known are combinations with further active compounds for widening the activity spectrum and/or for protecting crop plants (for example by safeners, antidotes).

Chemical compounds having herbicidal activity can be formulated in various ways, depending on the prevailing biological and/or chemico-physical parameters. Suitable possibilities of formulation are, for example: wettable powders which can be dispersed in water (WP), water-soluble powders (SP), water-soluble concentrates, emulsifiable concentrates (EC), emulsions (EW) such as oil-in-water and water-in-oil emulsions, sprayable solutions, suspensions concentrates (SC), oil-based dispersions (OD) or water-based dispersions, oil-miscible solutions, capsule suspensions (CS), dusts (DP), seed-dressing products, granules for soil application or application by broadcasting, granules (GR) in the form of microgranules, spray granules, coated granules and adsorption granules, water-dispersible granules (WG), water-soluble granules (SG), ULV formulations, microcapsules and waxes.

The individual formulation types are known in principle and are described, for example, in: Winnacker-Küchler, “Chemische Technologie”, [Chemical engineering], Volume 7, C. Hauser Verlag Munich, 4th Ed., 1986; van Valkenburg, “Pesticide Formulations”, Marcel Dekker N.Y., 1973; K. Martens, “Spray Drying Handbook”, 3rd Ed. 1979, G. Goodwin Ltd. London.

Emulsifiable concentrates are prepared by dissolving the active compound in an organic solvent, for example butanol, cyclohexanone, dimethylformamide, xylene or else high-boiling hydrocarbons such as saturated or unsaturated aliphatic or alicyclic substances, aromatic substances or mixtures of the organic solvents with addition of one or more ionic and/or nonionic surfactants (emulsifiers). The following are examples of emulsifiers which may be used: calcium alkylarylsulphonates, such as Ca dodecylbenzenesulphonate or nonionic emulsifiers, such as fatty acid polyglycol esters, alkylaryl polyglycol ethers, fatty alcohol polyglycol ethers, propylene oxide/ethylene oxide condensates, alkyl polyethers, sorbitan fatty acid esters, polyoxyethylene polyoxyethylene sorbitan fatty acid esters or polyoxyethylene sorbitol esters.

Suspension concentrates may be water- or oil-based. They can be prepared, for example, by wet-milling by means of commercially available bead mills, if appropriate with addition of surfactants as, for example, have already been listed above in the case of the other formulation types.

Emulsions, for example oil-in-water emulsions (EW), can be prepared for example by means of stirrers, colloid mills and/or static mixers using aqueous organic solvents and, if appropriate, surfactants as, for example, have already been listed above in the case of the other formulation types.

For further details on the formulation of crop protection agents see, for example, G. C. Klingman, “Weed Control as a Science”, John Wiley and Sons, Inc., New York, 1961, pages 81-96 and J. D. Freyer, S. A. Evans, “Weed Control Handbook”, 5th Ed., Blackwell Scientific Publications, Oxford, 1968, pages 101-103.

In general, the agrochemical preparations comprise from 0.1 to 99% by weight, in particular from 0.1 to 95% by weight, of active compounds.

Formulations of individual active compounds, like formulations of combinations of a plurality of active compounds for crop protection, should generally have high chemical and physical stability, should be easy to apply and easy to use and have broad biological action combined with high selectivity with respect to the active compounds used, and should additionally be easy to formulate in the preparation process. Of particular importance here is in particular high chemical and physical stability (storage stability) of the formulation.

For individual agrochemically active compounds, for improving the stability of these active compounds, it may be expedient and important to provide these compounds as non-aqueous (water-free) or at least low-water formulations. This also applies, for example, to sulfonylureas. In some cases, it is not possible to achieve complete absence of water in a formulation because the other components of the formulation, as a result of the way in which they were produced, have a non-avoidable content of residual water. For the purpose of the invention, “low-water” refers to the presence of such residual amounts of water.

To exclude hydrolytical decomposition of sulfonylureas, in particular the decomposition of the compounds of the formula (I) and their salts in a formulation, it is possible to prepare a formulation with the aim to obtain a water-free formulation. However, in certain cases this may involve considerably technical expenditure, in particular since many surfactants, owing to the way in which they were produced, comprise a small amount of water.

However, surprisingly, in many cases it is not necessary to prepare the formulations completely water-free. Within certain limits, the presence of water is entirely tolerated. Thus, it has been found that in general a water content of up to 2% by weight, in exceptional cases up to 10% by weight, in the suspension concentrate has only a slight, if any, negative effect on stability. The total water content tolerated depends strongly on the actual hydrolytic sensitivity of the active compounds and the solubility of the water in the solvent/surfactant mixture in question. In general, the water content of the product is in the range of from 0 to 30% by weight, preferably from 0 to 20% by weight, in particular from 0 to 3% by weight, very particularly from 0 to 2% by weight, very particularly preferably from 0 to 1% by weight.

The documents EP 2 052 603 A1 and EP 2 052 604 A1 disclose aqueous formulations of salts of 2-iodo-N-[(4-methoxy-6-methyl-1,3,5-triazin-2-yl)carbamoyl]benzenesulfonamide which, in addition to the solvent water, also comprise non-polar organic solvents, for example aromatics, aliphatic hydrocarbons, paraffins, mineral oil fractions or vegetable oil, and also the use of these formulations for controlling unwanted vegetation.

WO 01/82693 discloses liquid formulations of herbicidally active compounds from the group of the inhibitors of acetolactate synthase (ALS inhibitors), such as sulfonylureas, which, to increase storage stability, comprise one or more derivatives of polycarboxylic acids. The polycarboxylic acids added to the formulations exemplified in WO 01/82693 comprising the agrochemically active compound iodosulfuron is Trition GR 7 ME.

WO 01/82693 mentions certain solvents suitable for sulfonylureas. The solvents mentioned in WO 01/82693 include inter alia propylene carbonate, acid amides such as DMF or Hallcomid M 8/10 or Solvesso 200, where WO 01/82693 does not ascribe a particular suitability for the stable formulation of sulfonylureas to any of the solvents used. WO 01/82693 mentions the solvents rapeseed oil methyl ester, tetrahydrofurfuryl alcohol (THF) and triacetin (glycerin triacetate) as being preferred.

The provision of sulfonylurea-comprising formulations having low active compound concentrations does not form part of the subject matter of WO 01/82693. The active compound concentrations of the examples given in WO 01/82693 are relatively high. In practice, however, the provision of individual active compounds at low concentrations and at the same time in a stable form may cause problems.

However, the provision of chemically stable active compound formulations for agriculture is quite generally a big challenge for the future. The challenge will consist in the fact that, at different locations, in some cases changing, underlying specific local conditions have to be addressed, since the storage of agrochemicals at the farm product traders site or at the site where they are consumed at the agricultural premises is rarely climatized. Not least because of global warming, it has to be anticipated that in the future storage stability requirements for agrochemicals will increase.

Depending on the active compound concentration, i.e. in particular at low active compound concentrations, it is desirable to provide low-volume formulations as these are distinguished by flexible application options, for example as ready-to-use formulations.

For the purpose of the present invention, a formulation is a low-volume formulation when 1 liter of the formulation comprises the minimum components which allow the formulation to be used for producing a spray liquor which can be used directly for controlling weeds on a specified field area of, for example, one hectare.

Furthermore, low-volume formulations have the advantage that resources of various types can be saved. Thus, low-volume formulations have, for example, the advantage that in the production of the formulation in addition to solvents it is also possible to save on packaging materials.

On this background, it is an object of the present invention to provide a crop protection formulation comprising an active compound of the formula (I), which formulation, at high storage stability, can also be applied in an advantageous manner and has high biological efficacy and also high crop plant compatibility.

In particular, it is an object to provide a liquid formulation which makes available the active compound mentioned in claim 1 as a ready-to-use formulation, where the active compound of the formula (I) in this formulation is storage-stable both at high and also in particular at low active compound concentrations.

This object is achieved by a liquid formulation comprising
a) the agrochemical salts of the active compound of the formula (I)

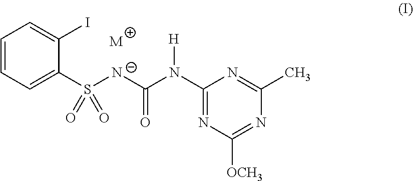

in which M⁺ is as defined above, and
b) one or more non-polar organic solvents selected from the group of the C₆-C₁₆-aromatics mixtures
   the Solvesso series (Exxon) and/or
   the Caromax series (Carless), and also
optionally further non-polar organic solvents.

The agrochemicall active compound of the formula (I) according to component a) is 2-iodo-N-[(4-methoxy-6-methyl-1,3,5-triazin-2-yl)carbamoyl]benzenesulfonamide, which is distinguished by its herbicidal activity.

In preferred embodiments, the cation M⁺ of the active compound of the formula (I) is a sodium ion, a potassium ion, a lithium ion, a magnesium ion, a calcium ion, a NH₄⁺ ion, a (2-hydroxyeth-1-yl)ammonium ion, a bis-N,N-(2-hydroxyeth-1-yl)ammonium ion, a tris-N,N,N-(2-hydroxyeth-1-yl)ammonium ion, a methylammonium ion, a dimethylammonium ion, a trimethylammonium ion, a tetramethylammonium ion, an ethylammonium ion, a diethylammonium ion, a triethylammonium ion, a tetraethylammonium ion, an isopropylammonium ion, a diisopropylammonium ion, a tetrapropylammonium ion, a tetrabutylammonium ion, a 2-(2-hydroxyeth-1-oxy)eth-1-ylammonium ion, a di-(2-hydroxyeth-1-yl)ammonium ion, a trimethylbenzylammonium ion, a tri-((C₁-C₄)-alkyl)sulfonium ion or a tri-((C₁-C₄)-alkyl)oxonium ion, a benzylammonium ion, a 1-phenylethylammonium ion, a 2-phenylethylammonium ion, a diisopropylethylammonium ion, a pyridinium ion, a piperidinium ion, an imidazolium ion, a morpholinium ion or a 1,8-diazabicyclo[5.4.0]undec-7-enium ion.

Particular preference is given to compounds of the active compound of the formula (I) in which the cation M⁺ is a sodium ion, a potassium ion, a magnesium ion, a calcium ion or an NH₄⁺ ion.

Most preference is given to compounds of the active compound of the formula (I) in which the cation M⁺ is a sodium ion or a potassium ion.

Surprisingly, it has been found that in particular in the non-polar solvents according to component b) the active compound according to formula (I) gives a chemically stable formulation which has a sufficiently high storage stability. The person skilled in the art would expect that the active compound of the formula (I), which is present as a salt, is more soluble in a polar solvent and also has higher storage stability therein. However, contrary to expectation, this is not the case.

Since, surprisingly, the active compound according to formula (I) already gives a chemically stable formulation in non-polar solvents, in particular in those of the Solvesso series (Exxon) and/or in those of the Caromax series (Carless), the addition of stabilizing Triton for providing a formulation which, as only agrochemically active compound, comprises the active compound according to formula (I), is not necessarily required. In contrast, in the general teaching known from the prior art (see WO 01/82693), in the formulation of sulfonylureas a sulfosuccinate, for example Triton or sodium di(ethylhexyl)sulfosuccinate (Na-DOS), is always employed in the range of from 15% by weight to more than 90% by weight.

Nevertheless, in preferred embodiments of the invention, the addition of a detergent to the formulation according to the invention is not excluded. Thus, the presence of a detergent may be required in particular when the formulation according to the invention, as provided in preferred embodiments, comprises a further agrochemically active compound in addition to the active compound of the formula (I).

In comparative examples, it was found that the chemical decomposition of the active compound of the formula (I) in an EC formulation based on polar organic solvents after 2 weeks of storage at 54° C. is well above the value found for an otherwise identical formulation based on the non-polar solvent Solvesso 200.

Here, it has to be emphasized that with the formulation according to the invention it is possible to provide the active compound of the formula (I) even in low concentrations, i.e. the proportion by weight of component a) of the liquid formulation is up to 3% by weight.

However, the formulation according to the invention may comprise higher concentrations of the active compound of the formula (I), i.e. up to 30% by weight, where in these cases the active compound may also be present in partially undissolved dispersed form.

Non-polar organic solvents according to component b) suitable for the formulation according to the invention are in particular aliphatic or aromatic hydrocarbons, for example mineral oils, paraffins, C₆-C₁₆-aromatics mixtures such as the Solvesso series (Exxon), for example with the types Solvesso 100, Solvesso 150, Solvesso 150 ND, Solvesso 200 and Solvesso 200ND, or the Caromax series (Carless) with the types Caromax 28 and Caromax 28 LN, and C6-C20-aliphatics which may be straight-chain or branched, and also the products of the Shellsol series, types T and K or BP-nparaffins.

The total proportion of component b) in the liquid formulations according to the invention is generally between 10 and 90% by weight, preferably in the range from 20 to 80% by weight.

In addition to components a) and b), the liquid formulation may optionally also comprise further components, for example:
c) one or more derivatives of polycarboxylic acids,
d) one or more agrochemicals such as herbicides different from the herbicidally active compound of the formula (I), and also insecticides, fungicides, safeners, growth regulators or fertilizers,
e) customary auxiliaries and additives, or
f) tank mix components.

The addition of components which are insoluble in the continuous phase or of agrochemically active compounds which are poorly soluble or insoluble in particular at relatively high concentrations may also result in dispersions. Accordingly, the preferred embodiments of the present formulations also include dispersions in addition to emulsions.

The polycarboxylic acid derivatives which are present in the formulations according to the invention as component c) are, for example, their esters, amides or salts, and the sulfonates, sulfates, phosphates or carboxylates derived from the polycarboxylic acids or, for example, their esters, amides and salts.

Suitable polycarboxylic acids are, for example, dicarboxylic acids, tricarboxylic acids, tetracarboxylic acids or else carboxylic acids of higher functionality, preferably having 2-20 carbon atoms. Also suitable are polymeric polycarboxylic acids, preferably having molecular weights of up to 2,000 g/mol. Examples of polycarboxylic acids are oxalic, malonic, succinic, glutaric, adipic, pimelic, sebacic, azelaic, suberic, maleic, phthalic, terephthalic, mellitic, trimellitic, polymaleic, polyacrylic and polymethacrylic acid and also co- or terpolymers comprising maleic, acrylic and/or methacrylic acid units.

Formally, the polycarboxylic acid esters can be obtained, for example, by reacting the free carboxylic acids with mono-, di- or polyhydric alcohols or alkoxylation products thereof, the esters being produced, for example, by reaction of “activated” carboxylic acids such as carboxylic anhydrides with the alkoxylates or alcohols mentioned. Furthermore, instead of the alcohol alkoxylates, it is also possible to use alkoxylates based on fatty acids, amides or amines for esterification with the polycarboxylic acids mentioned, if they have at least one esterifiable hydroxyl group.

Formally, the polycarboxamides can be produced, for example, by reacting the carboxylic acids with primary or secondary amines or with ammonia. The primary and secondary amines may, for example, have linear, cyclic or branched aromatic, aliphatic and/or cycloaliphatic C₁-C₂₀-hydrocarbon radical substituents, preferably C₁-C₂₀-alkyl radicals, where cycloaliphatic hydrocarbon radicals may contain additional hetero ring atoms, for example morpholine. The C₁-C₂₀-hydrocarbon radicals may also be replaced by (poly)alkylene oxide units, such as (poly)ethylene oxide, (poly)propylene oxide or (poly)butylene oxide. Examples are the amino compounds ethanolamine, diethanolamine, 1-amino-2-propanol or amino-butanol, and their (poly)alkylene oxide adducts. Also suitable are alkyl ethers or alkyl esters prepared from these compounds and having linear or branched aromatic, aliphatic and/or cycloaliphatic mono-, di- or polyfunctional C₁-C₂₀-alcohols. Furthermore suitable are also the oxidation products of the alkoxylated amines, such as glycine and salts thereof.

Suitable polycarboxylic acid salts are, for example, metal salts, such as alkali metal or alkaline earth metal salts, or salts having organic counterions, such as organic ammonium, sulfonium or phosphonium ions.

If the polycarboxylic acids or polycarboxylic acid derivatives such as esters, amides or salts have reactive groups such as double bonds, it is possible to obtain further polycarboxylic acid derivatives by reacting these groups, for example
by oxidation and ring-opening and subsequent reaction with (poly)alkylene oxides and subsequent reaction with phosphoric anhydride or sulfuric acid,
by oxidation and ring-opening and subsequent reaction with alkylating agents, such as dimethyl sulfate,
by oxidation and ring-opening and subsequent reaction with carboxylic acids, such as fatty acids,
by oxidation and ring-opening and subsequent reaction with phosphoric anhydride or sulfuric acid and subsequent reaction with (poly)alkylene oxides, or
by reaction with sodium disulfide or potassium disulfide.

The resulting polycarboxylic acid derivatives for their part can be reacted once or more than once in one of the manners described above—one possibility is, for example, an alkoxylation of an acidic phosphated polycarboxylic ester alkoxylate or polycarboxamide alkoxylate, where the resulting and further reaction products of the polycarboxylic acids or polycarboxylic acid derivatives, too, are suitable derivatives of polycarboxylic acids for the purpose of the present invention.

Preferred are compounds from the group of the gemini surfactants, i.e. amphiphilic compounds having two identical head groups and/or compounds from the group of the sulfosuccinates.

Preferred compounds from the group of the sulfosuccinates correspond to the formula (II):

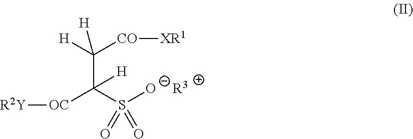

in which
R¹, R² independently of one another are identical or different and are H, substituted or unsubstituted C₁-C₃₀-hydrocarbon radicals, such as C₁-C₃₀-alkyl, or (poly)alkylene oxide adducts,
R³ is a cation, for example a metal cation, such as an alkali metal or alkaline earth metal cation, an ammonium cation, such as NH₄, alkyl-, alkylaryl- or poly(arylalkyl)phenyl-ammonium cation or (poly)alkylene oxide adducts thereof, or an amino-terminated (poly)alkylene oxide adduct, and
X, Y independently of one another are identical or different and are O or NR⁴, where R⁴ is H, a substituted or unsubstituted C₁-C₃₀-hydrocarbon radical, such as C₁-C₃₀-alkyl, C₁-C₃₀-alkyl-C₆-C₁₄-aryl or poly(C₆-C₁₄-aryl-C₁-C₃₀-alkyl)phenyl, dicarboxyethyl or a (poly)alkylene oxide adduct.

Preferred compounds from the group of the gemini surfactants have the formula (III) R⁵—CO—NA-R⁶—NB—CO—R⁷ or (N)R⁵—O—CO—CH(SO₃M)-R⁶—CH(SO₃M)-CO—O—R⁷, in which
R⁵, R⁷ independently of one another are identical or different and are straight-chain, branched or cyclic saturated or unsaturated hydrocarbon radicals having 1 to 30 carbon atoms, preferably 3 to 17 carbon atoms, in particular ethylpentyl, trimethylpentyl, oleyl or propyl,
R⁶ is a spacer of a straight-chain or branched chain having 2 to 100 carbon atoms which contains 0 to 20 oxygen atoms, 0 to 4 sulfur atoms and/or 0 to 3 phosphorus atoms and which has 0 to 20 functional side groups, such as hydroxyl, carbonyl, carboxyl, amino and/or acylamino groups, and which contains 0 to 100, preferably 0 to 20 alkoxy groups, and
A, B independently of one another are identical or different and are polyalkylene oxide radicals having a terminal OH, C₁-C₂₀-alkyl, carboxyethyl, carboxymethyl, sulfonic acid, sulfuric acid, phosphoric acid or betaine grouping, and
M is a cation, for example a metal cation, such as an alkali metal or alkaline earth metal cation, an ammonium cation, such as NH₄, alkyl-, alkylaryl- or poly(arylalkyl)phenyl-ammonium cation or (poly)alkylene oxide adducts thereof, or an amino-terminate (poly)alkylene oxide adduct.

(Poly)alkylene oxide adducts for the purposes of this description are reaction products of alkoxylatable starting materials such as alcohols, amines, carboxylic acids, such as fatty acids, hydroxy- or amino-functional carboxylic esters (examples being triglycerides based on castor oil) or carboxamides with alkylene oxides, the (poly)alkylene oxide adducts having at least one alkylene oxide unit, but generally being polymeric, i.e., having 2-200, preferably 5-150, alkylene oxide units. Among the alkylene oxide units, ethylene oxide, propylene oxide, and butylene oxide units, especially ethylene oxide units, are preferred. The (poly)alkylene oxide adducts described may be composed of alike or of different alkylene oxides, as for example of blockwise or randomly arranged ethylene oxide and propylene oxide, so that the present specification also encompasses “mixed” alkylene oxide adducts of this kind.

Polycarboxylic acid derivatives which are present in accordance with the invention originate particularly preferably from the group of the sulfosuccinates, for example
a1) sulfosuccinate which is esterified once or twice with linear, cyclic or branched aliphatic, cycloaliphatic and/or aromatic alcohols, having, for example, 1 to 22 carbon atoms in the alkyl radical, preferably mono- or dialkali metal sulfosuccinate, in particular mono- or disodium sulfosuccinate, which is esterified once or twice with methanol, ethanol, (iso)propanol, (iso)butanol, (iso)pentanol, (iso)hexanol, cyclohexanol, (iso)heptanol, (iso)octanol (in particular: ethylhexanol), (iso)nonanol, (iso)decanol, (iso)undecanol, (iso)dodecanol or (iso)tridecanol,
a2) sulfosuccinate which is esterified once or twice with (poly)alkylene oxide adducts of alcohols, having, for example, 1 to 22 carbon atoms in the alkyl radical and 1 to 200, preferably 2 to 200, alkylene oxide units in the (poly)alkylene oxide moiety, preferably mono- or dialkali metal sulfosuccinate, in particular mono- or disodium sulfosuccinate, which is esterified once or twice with dodecyl/tetradecyl alcohol+2-5 mol of ethylene oxide or with i-tridecyl+3 mol of ethylene oxide,
a3) the dialkali metal salt, preferably the disodium salt, of maleic anhydride which has been reacted with one equivalent of an amine or an amino-terminated (poly)alkylene oxide adduct of an alcohol, an amine, a fatty acid, an ester or an amide and then sulfonated, having, for example, 1 to 22 carbon atoms in the alkyl radical and 1 to 200, preferably 2 to 200, oxyalkylene units in the (poly)alkylene oxide moiety, preferably the disodium salt of maleic anhydride which has been reacted with one equivalent of coconut fatty amine and then sulfonated,
a4) the dialkali metal salt, preferably the disodium salt, of maleic anhydride which has been reacted with one equivalent of an amide or a (poly)alkylene oxide adduct of an amide and then sulfonated, having, for example, 1 to 22 carbon atoms in the alkyl radical and 1 to 200, preferably 2 to 200, oxyalkylene units in the (poly)alkylene oxide moiety, preferably the disodium salt of maleic anhydride which has been reacted with one equivalent of oleylamide+2 mol of ethylene oxide and then sulfonated, and/or
a5) the tetraalkali metal salt, preferably the tetrasodium salt, of N-(1,2-dicarboxy-ethyl)-N-octadecylsulfosuccinamate.

Examples of sulfosuccinates of groups a1) to a5) which are commercially available and preferred within the context of the present invention are listed below:
a1) sodium dialkylsulfosuccinates, for example sodium diisooctylsulfosuccinate, commercially available, for example, in the form of the Aerosol® brands (Cytec), the Agrilan® or Lankropol® brands (Akzo Nobel), the Empimin® brands (Albright&Wilson), the Cropol® brands (Croda), the Lutensit® brands (BASF) or the Imbirol®, Madeol® or Polirol® bands (Cesalpinia), or sodium di(2-ethylhexyl)sulfosuccinates, commercially available, for example, in the form of the Triton® brands (Union Carbide) such as Triton® GR-5M and Triton® GR-7ME, and also Synergen WO2, WO3 or WO9 (Clariant),
a2) disodium alcohol polyethylene glycol ether semisulfosuccinate, commercially available, for example, in the form of the Aerosol® brands (Cytec), the Marlinat® or Sermul® brands (Condea), the Empicol® brands (Albright&Wilson), the Secosol® brands (Stepan), the Geropon® brands (Rhodia), the Disponil® or Texapon® brands (Cognis) or the Rolpon® brands (Cesalpinia),
a3) disodium N-alkylsulfosuccinamate, commercially available, for example, in the form of the Aerosol® brands (Cytec), the Rewopol® or Rewoderm® brands (Rewo), the Empimin® brands (Albright&Wilson), the Geropon® brands (Rhodia) or the Polirol® brands (Cesalpinia),
a4) disodium fatty acid amide polyethylene glycol ether semisulfosuccinate, commercially available, for example, in the form of the Elfanol® or Lankropol® brands (Akzo Nobel), the Rewoderm®, Rewocid® or Rewopol® brands (Rewo), the Emcol® brands (Witco), the Standapol® brands (Cognis) or the Rolpon® brands (Cesalpinia), and
a5) tetrasodium N-(1,2-dicarboxyethyl)-N-octadecylsulfosuccinamate, commercially available, for example, in the form of Aerosol 22® (Cytec).

If the liquid formulations according to the invention comprise derivatives of polycarboxylic acids, in particular sulfosuccinates, their proportion by weight is generally from 2% by weight to 50% by weight, preferably from 5% by weight to 30% by weight.

The liquid formulations of the present invention may comprise, as further optional component (surfactants and/or polymers), for example one or more ionic or nonionic surfactants and/or polymers and/or one or more components based on silicone, such as, for example, trisiloxane surfactants, derivatives of polydimethylsiloxanes and/or silicone oils. Examples of preferred components c) are (poly)alkylene oxide adducts, in particular of fatty alcohols and/or fatty acids and/or components which are insoluble in the continuous phase. Examples of (poly)alkylene oxide adducts are Soprophor CY8® (Rhodia), Genapol X-060®, Genapol X-080® or Genagen MEE® (methyl ester ethoxylates) (Clariant) and other terminally-capped surfactants having a methyl, ethyl, n-propyl, isopropyl, n-butyl, tert-butyl, isobutyl, sec-butyl or acetyl group as terminal grouping. Components which are insoluble in the continuous phase and which can be used are, for example, anionic surfactants, such as Hostapur OSB® (Clariant), Netzer IS® (Clariant), Galoryl DT 201® (CFPI), Tamol® (BASF) or Morwet D 425® (Witco).

The total amount of surfactants and/or polymers in the liquid formulations according to the invention is generally between 0 and 60% by weight, preferably in the range from 5 to 20% by weight.

As optional agrochemically active compounds according to component d), the formulation may comprise, for example, agrochemically active compounds different from component a), such as herbicides, fungicides, insecticides, plant growth regulators and the like. The agrochemically active compounds according to component d) may be present in the hydrocarbon b) in suspended form and/or in dissolved form.

Suitable agrochemicals of component d) are, for example, herbicidal compounds from the group of the imidazolinones, pyrimidinyloxypyridinecarboxylic acid derivatives, pyrimidyloxybenzoic acid derivatives or sulfonamides, such as triazolopyrimidinesulfonamides or sulfonylaminocarbonyltriazolinones, preferably phenylsulfonylaminocarbonyltriazolinones, for example flucarbazone or propoxycarbazone and/or salts thereof, or sulfonylureas, preferably phenylsulfonylureas.

Preferred ALS inhibitors originate from the group of the sulfonylureas, for example pyrimidinyl- or triazinylaminocarbonyl[benzene-, -pyridine-, -pyrazole-, -thiophene- and -(alkylsulfonyl)alkylamino]sulfamides. Preferred substituents on the pyrimidine ring or the triazine ring are alkoxy, alkyl, haloalkoxy, haloalkyl, halogen or dimethylamino, it being possible to combine all substituents independently of one another. Preferred substituents in the benzene, pyridine, pyrazole, thiophene or (alkylsulfonyl)alkylamino moiety are alkyl, alkoxy, halogen, such as F, Cl, Br or I, amino, alkylamino, dialkylamino, acylamino, such as formylamino, nitro, alkoxycarbonyl, aminocarbonyl, alkylaminocarbonyl, dialkylaminocarbonyl, alkoxyaminocarbonyl, haloalkoxy, haloalkyl, alkylcarbonyl, alkoxyalkyl, alkylsulfonylaminoalkyl, (alkanesulfonyl)alkylamino. Such suitable sulfonylureas are, for example,
A1) phenyl- and benzylsulfonylureas and related compounds, for example 1-(2-chlorophenylsulfonyl)-3-(4-methoxy-6-methyl-1,3,5-triazin-2-yl)urea (chlorsulfuron),
1-(2-ethoxycarbonylphenylsulfonyl)-3-(4-chloro-6-methoxypyrimidin-2-yl)urea (chlorimuron-ethyl),
1-(2-methoxyphenylsulfonyl)-3-(4-methoxy-6-methyl-1,3,5-triazin-2-yl)urea (metsulfuron-methyl),
1-(2-chloroethoxyphenylsulfonyl)-3-(4-methoxy-6-methyl-1,3,5-triazin-2-yl)urea (triasulfuron),
1-(2-methoxycarbonylphenylsulfonyl)-3-(4,6-dimethylpyrimidin-2-yl)urea (sulfumeturon-methyl),
1-(2-methoxycarbonylphenylsulfonyl)-3-(4-methoxy-6-methyl-1,3,5-triazin-2-yl)-3-methylurea (tribenuron-methyl),
1-(2-methoxycarbonylbenzylsulfonyl)-3-(4,6-dimethoxypyrimidin-2-yl)urea (bensulfuron-methyl),
1-(2-methoxycarbonylphenylsulfonyl)-3-(4,6-bis-(difluoromethoxy)pyrimidin-2-yl)urea (primisulfuron-methyl),
3-(4-ethyl-6-methoxy-1,3,5-triazin-2-yl)-1-(2,3-dihydro-1,1-dioxo-2-methylbenzo-[b]thiophene-7-sulfonyl)urea (EP-A 0 796 83),
3-(4-ethoxy-6-ethyl-1,3,5-triazin-2-yl)-1-(2,3-dihydro-1,1-dioxo-2-methylbenzo[b]-thiophene-7-sulfonyl)urea (EP-A 0 079 683),
3-(4-methoxy-6-methyl-1,3,5-triazin-2-yl)-1-(2-methoxycarbonyl-5-iodophenylsulfonyl)urea (iodosulfuron-methyl and its salts, such as the sodium salt, WO 92/13845),
DPX-66037, triflusulfuron-methyl (see Brighton Crop Prot. Conf.—Weeds—1995, p. 853),
CGA-277476, (see Brighton Crop Prot. Conf.—Weeds—1995, p. 79),
methyl 2-[3-(4,6-dimethoxypyrimidin-2-yl)ureidosulfonyl]-4-methanesulfonamidomethylbenzoate (mesosulfuron-methyl and its salts, such as the sodium salt, WO 95/10507),
N,N-dimethyl-2-[3-(4,6-dimethoxypyrimidin-2-yl)ureidosulfonyl]-4-formylaminobenzamide (foramsulfuron and its salts, such as the sodium salt, WO 95/01344);
A2) thienylsulfonylureas, for example
1-(2-methoxycarbonylthiophen-3-yl)-3-(4-methoxy-6-methyl-1,3,5-triazin-2-yl)urea (thifensulfuron-methyl);
A3) pyrazolylsulfonylureas, for example
1-(4-ethoxycarbonyl-1-methylpyrazol-5-ylsulfonyl)-3-(4,6-dimethoxypyrimidin-2-yl)urea (pyrazosulfuron-methyl);
methyl 3-chloro-5-(4,6-dimethoxypyrimidin-2-ylcarbamoylsulfamoyl)-1-methylpyrazole-4-carboxylate (EP-A 0 282 613);
methyl 5-(4,6-dimethylpyrimidin-2-ylcarbamoylsulfamoyl)-1-(2-pyridyl)pyrazole-4-carboxylate (NC-330, see Brighton Crop Prot. Conference ‘Weeds’ 1991, Vol. 1, p. 45 ff.),
DPX-A8947, azimsulfuron, (see Brighton Crop Prot. Conf. ‘Weeds’ 1995, p. 65);
A4) sulfonediamide derivatives, for example
3-(4,6-dimethoxypyrimidin-2-yl)-1-(N-methyl-N-methylsulfonylaminosulfonyl)urea (amidosulfuron) and its structural analogs (EP-A 0 131 258 and Z. Pfl. Krankh. Pfl. Schutz, special issue XII, 489-497 (1990));
A5) pyridylsulfonylureas, for example
1-(3-N,N-dimethylaminocarbonylpyridin-2-ylsulfonyl)-3-(4,6-dimethoxypyrimidin-2-yl)urea (nicosulfuron),
1-(3-ethylsulfonylpyridin-2-ylsulfonyl)-3-(4,6-dimethoxypyrimidin-2-yl)urea (rimsulfuron),
methyl 2-[3-(4,6-dimethoxypyrimidin-2-yl)ureidosulfonyl]-6-trifluoromethyl-3-pyridinecarboxylate, sodium salt (DPX-KE 459, flupyrsulfuron, see Brighton Crop Prot. Conf. Weeds, 1995, p. 49),
   pyridylsulfonylureas as described, for example, in DE-A 40 00 503 and DE-A 40 30 577, preferably those of the formula

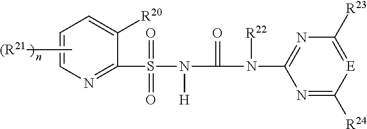

in which
E is CH or N, preferably CH,
R²⁰ is iodine or NR²⁵R²⁶,
R²¹ is hydrogen, halogen, cyano, (C₁-C₃)-alkyl, (C₁-C₃)-alkoxy, (C₁-C₃)-haloalkyl, (C₁-C₃)-haloalkoxy, (C₁-C₃)-alkylthio, (C₁-C₃)-alkoxy-(C₁-C₃)-alkyl, (C₁-C₃)-alkoxy-carbonyl, mono- or di-((C₁-C₃)-alkyl)amino, (C₁-C₃)-alkylsulfinyl or -sulfonyl, SO₂—NR^{x}R^{y} or CO—NR^{x}R^{y}, in particular hydrogen,
R^{x}, R^{y} independently of one another are hydrogen, (C₁-C₃)-alkyl, (C₁-C₃)-alkenyl, (C₁-C₃)-alkynyl or together are —(CH₂)₄—, —(CH₂)₅— or —(CH₂)₂—O—(CH₂)₂—,
n is 0, 1, 2 or 3, preferably 0 or 1,
R²² is hydrogen or CH₃,
R²³ is halogen, (C₁-C₂)-alkyl, (C₁-C₂)-alkoxy, (C₁-C₂)-haloalkyl, in particular CF₃, (C₁-C₂)-haloalkoxy, preferably OCHF₂ or OCH₂CF₃,
R²⁴ is (C₁-C₂)-alkyl, (C₁-C₂)-haloalkoxy, preferably OCHF₂, or (C₁-C₂)-alkoxy,
R²⁵ is (C₁-C₄)-alkyl,
R²⁶ is (C₁-C₄)-alkylsulfonyl or
R²⁵ and R²⁶ together are a chain of the formula —(CH₂)₃SO₂— or —(CH₂)₄SO₂—, for example 3-(4,6-dimethoxypyrimidin-2-yl)-1-(3-N-methylsulfonyl-N-methylaminopyridin-2-yl)sulfonylurea, or salts thereof;
A6) alkoxyphenoxysulfonylureas as described, for example, in EP-A 0 342 569, preferably those of the formula

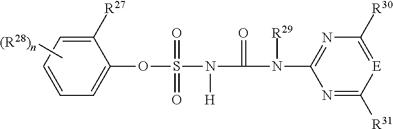

in which
E is CH or N, preferably CH,
R²⁷ is ethoxy, propoxy or isopropoxy,
R²⁸ is halogen, NO₂, CF₃, CN, (C₁-C₄)-alkyl, (C₁-C₄)-alkoxy, (C₁-C₄)-alkylthio or (C₁-C₃)-alkoxy-carbonyl, preferably in the 6-position on the phenyl ring,
n is 0, 1, 2 or 3, preferably 0 or 1,
R²⁹ is hydrogen, (C₁-C₄)-alkyl or (C₃-C₄)-alkenyl,
R³⁰, R³¹ independently of one another are halogen, (C₁-C₂)-alkyl, (C₁-C₂)-alkoxy, (C₁-C₂)-haloalkyl, (C₁-C₂)-haloalkoxy or (C₁-C₂)-alkoxy-(C₁-C₂)-alkyl, preferably OCH₃ or CH₃, for example 3-(4,6-dimethoxypyrimidin-2-yl)-1-(2-ethoxyphenoxy)sulfonylurea or salts thereof;
A7) imidazolylsulfonylureas, for example

MON 37500, sulfosulfuron (see Brighton Crop Prot. Conf. ‘Weeds’, 1995, p. 57), and other related sulfonylurea derivatives and mixtures thereof.

Typical representatives of these active compounds are, inter alia, the compounds listed below: amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl-sodium, halosulfuron-methyl, imazosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, triflusulfuron-methyl, iodosulfuron-methyl and its sodium salt (WO 92/13845), mesosulfuron-methyl and its sodium salt (Agrow No. 347, Mar. 3, 2000, page 22 (PJB Publications Ltd. 2000)) and foramsulfuron and its sodium salt (Agrow No. 338, Oct. 15, 1999, page 26 (PJB Publications Ltd. 1999)).

The active compounds listed above are known, for example from “The Pesticide Manual”, 12th edition (2000), The British Crop Protection Council, or from the literature references following the individual active compounds.

Other suitable ALS inhibitors are, for example,
B) imidazolinones, for example
methyl 2-(4-isopropyl-4-methyl-5-oxo-2-imidazolin-2-yl)-5-methylbenzoate and 2-(4-isopropyl-4-methyl-5-oxo-2-imidazolin-2-yl)-4-methylbenzoic acid (imazamethabenz),
5-ethyl-2-(4-isopropyl-4-methyl-5-oxo-2-imidazolin-2-yl)pyridine-3-carboxylic acid (imazethapyr),
2-(4-isopropyl-4-methyl-5-oxo-2-imidazolin-2-yl)quinoline-3-carboxylic acid (imazaquin),
2-(4-isopropyl-4-methyl-5-oxo-2-imidazolin-2-yl)pyridine-3-carboxylic acid (imazapyr),
5-methyl-2-(4-isopropyl-4-methyl-5-oxo-2-imidazolin-2-yl)pyridine-3-carboxylic acid (imazethamethapyr);
C) triazolopyrimidinesulfonamides, for example
N-(2,6-difluorophenyl)-7-methyl-1,2,4-triazolo[1,5-c]pyrimidine-2-sulfonamide (flumetsulam),
N-(2,6-dichloro-3-methylphenyl)-5,7-dimethoxy-1,2,4-triazolo[1,5-c]pyrimidine-2-sulfonamide,
N-(2,6-difluorophenyl)-7-fluoro-5-methoxy-1,2,4-triazolo[1,5-c]pyrimidine-2-sulfonamide,
N-(2,6-dichloro-3-methylphenyl)-7-chloro-5-methoxy-1,2,4-triazolo[1,5-c]pyrimidine-2-sulfonamide,
N-(2-chloro-6-methoxycarbonyl)-5,7-dimethyl-1,2,4-triazolo[1,5-c]pyrimidine-2-sulfonamide (EP-A 0 343 752, U.S. Pat. No. 4,988,812);
D) pyrimidinyloxypyridinecarboxylic acid or pyrimidinyloxybenzoic acid derivatives, for example
benzyl 3-(4,6-dimethoxypyrimidin-2-yl)oxypyridine-2-carboxylate (EP-A 0 249 707),
methyl 3-(4,6-dimethoxypyrimidin-2-yl)oxypyridine-2-carboxylate (EP-A 0 249 707),
2,6-bis[(4,6-dimethoxypyrimidin-2-yl)oxy]benzoic acid (EP-A 0 321 846),
1-(ethoxycarbonyloxyethyl) 2,6-bis[(4,6-dimethoxypyrimidin-2-yl)oxy]benzoate (EP-A 0 472 113).

Suitable sulfonamides are preferably sulfonamides of the formula (D1) and/or salts thereof.

R^{α}-(A)ₘ-SO₂—NR^{β}—CO—(NR^{γ})ₙ—R^{δ} (D1)

in which
R^{α} is a hydrocarbon radical, preferably an aryl radical, such as phenyl, which is unsubstituted or substituted, or a heterocyclic radical, preferably a heteroaryl radical, such as pyridyl, which is unsubstituted or substituted, where the radicals including substituents have 1-30 carbon atoms, preferably 1-20 carbon atoms, or R^{α} is an electron-withdrawing group, such as a sulfonamide radical,
R^{β} is a hydrogen atom or a hydrocarbon radical which is unsubstituted or substituted and, including substituents, has 1-10 carbon atoms, for example unsubstituted or substituted C₁-C₆-alkyl, preferably a hydrogen atom or methyl,
R^{γ} is a hydrogen atom or a hydrocarbon radical which is unsubstituted or substituted and, including substituents, has 1-10 carbon atoms, for example unsubstituted or substituted C₁-C₆-alkyl, preferably a hydrogen atom or methyl,
A is CH₂, O or NH, preferably O,
m is zero or 1,
n is zero or 1, preferably 1, and
R^{δ} is a heterocyclic radical, such as a pyridyl radical, a triazinyl radical or a triazolinone radical.

Examples of sulfonamides of the formula (D1) are sulfonylureas of the formula (D2) and/or salts thereof.

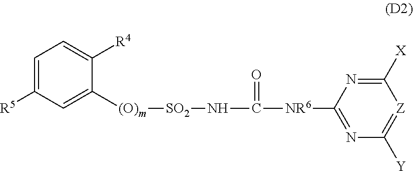

in which
R⁴ is C₁-C₄-alkoxy, preferably C₂-C₄-alkoxy, or CO—R^{a}, where R^{a} is OH, C₁-C₄-alkoxy or NR^{b}R^{c}, where R^{b} and R^{c} independently of one another are identical or different radicals H or C₁-C₄-alkyl,
R⁵ is halogen, preferably iodine, or (A)ₙ-NR^{d}R^{e}, where n is zero or 1, A is a group CR′R″, where R′ and R″ independently of one another are identical or different radicals H or C₁-C₄-alkyl, R^{d} is H or C₁-C₄-alkyl and R^{e} is an acyl radical, such as formyl, or C₁-C₄-alkylsulfonyl, and, if R⁴ is C₁-C₄-alkoxy, preferably C₂-C₄-alkoxy, R⁵ may also be H,
R⁶ is H or C₁-C₄-alkyl,
m is zero or 1,
X and Y independently of one another are identical or different radicals C₁-C₆-alkyl, C₁-C₆-alkoxy or C₁-C₆-alkylthio, where each of the three radicals mentioned is unsubstituted or substituted by one or more radicals from the group consisting of halogen, C₁-C₄-alkoxy and C₁-C₄-alkylthio, or are C₃-C₆-cycloalkyl, C₂-C₆-alkenyl, C₂-C₆-alkynyl, C₃-C₆-alkenyloxy or C₃-C₆-alkynyloxy, preferably C₁-C₄-alkyl or C₁-C₄-alkoxy, and
Z is CH or N.

Preference is given to sulfonylureas of the formula (D2) and/or salts thereof in which
a) R⁴ is CO—(C₁-C₄-alkoxy), R⁵ is halogen, preferably iodine, or R⁵ is CH₂—NHR^{e}, where R^{e} is an acyl radical, preferably C₁-C₄-alkylsulfonyl, and m is zero,
b) R⁴ is CO—N(C₁-C₄-alkyl)₂, R⁵ is NHR^{e}, where R^{e} is an acyl radical, preferably formyl, and m is zero, or
c) R⁴ is C₂-C₄-alkoxy, R⁵ is H and m is 1.

Particularly preferred ALS inhibitors are: iodosulfuron-methyl (A1) and its sodium salt (A2), mesosulfuron-methyl (A3) and its sodium salt (A4), foramsulfuron (A5) and its sodium salt (A6), flucarbazone (A7) and its sodium salt (A8), propoxycarbazone (A9) and its sodium salt (A10) and ethoxysulfuron (A11) and its sodium salt (A12), amidosulfuron (A13) and its sodium salt (A14).

The active compounds listed above are known, for example from “The Pesticide Manual”, 13th edition (2003), The British Crop Protection Council, or from the literature references given after the individual active compounds.

If the liquid formulations according to the invention comprise, as component e), ALS inhibitors, for example the sulfonamides mentioned above, such as sulfonamides of the formula (D1) and/or salts thereof, these can be present in suspended form and/or in dissolved form.

If the liquid formulations according to the invention contain herbicidally active compounds from the group of the ALS inhibitors, their proportion by weight is generally from 0.01 to 50% by weight, preferably from 0.1 to 30% by weight.

Whenever the term “acyl radical” is used in this description, this means the radical of an organic acid which is formally formed by removing an OH group from the organic acid, for example the radical of a carboxylic acid and radicals of acids derived therefrom, such as thiocarboxylic acid, unsubstituted or N-substituted iminocarboxylic acids or the radicals of carbonic monoesters, unsubstituted or N-substituted carbamic acids, sulfonic acids, sulfinic acids, phosphonic acids, phosphinic acids.

An acyl radical is preferably formyl or acyl from the group consisting of CO—R^{z}, CS—R^{z}, CO—OR^{z}, CS—OR^{z}, CS—SR^{z}, SOR^{z} and SO₂R^{z}, where R^{z} is in each case a C₁-C₁₀-hydrocarbon radical, such as C₁-C₁₀-alkyl or C₆-C₁₀-aryl, which is unsubstituted or substituted, for example by one or more substituents from the group consisting of halogen, such as F, Cl, Br or I, alkoxy, haloalkoxy, hydroxyl, amino, nitro, cyano and alkylthio, or R^{z} is aminocarbonyl or aminosulfonyl, where the two lastmentioned radicals are unsubstituted, N-monosubstituted or N,N-disubstituted, for example by substituents from the group consisting of alkyl and aryl. Acyl is, for example, formyl, haloalkylcarbonyl, alkylcarbonyl, such as (C₁-C₄)-alkyl-carbonyl, phenylcarbonyl, where the phenyl ring may be substituted, or alkyloxy-carbonyl, such as (C₁-C₄)-alkyloxycarbonyl, phenyloxycarbonyl, benzyloxycarbonyl, alkylsulfonyl, such as (C₁-C₄)-alkylsulfonyl, alkylsulfinyl, such as C₁-C₄-(alkylsulfinyl), N-alkyl-1-iminoalkyl, such as N—(C₁-C₄)-1-imino-(C₁-C₄)-alkyl, and other radicals of organic acids.

A hydrocarbon radical is a straight-chain, branched or cyclic and saturated or unsaturated aliphatic or aromatic hydrocarbon radical, for example alkyl, alkenyl, alkynyl, cycloalkyl, cycloalkenyl or aryl.

A hydrocarbon radical has preferably 1 to 40 carbon atoms, with preference 1 to 30 carbon atoms; with particular preference, a hydrocarbon radical is alkyl, alkenyl or alkynyl having up to 12 carbon atoms or cycloalkyl having 3, 4, 5, 6 or 7 ring atoms or phenyl.

An aromatic radical (aryl) is a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or heteroaromatic and unsubstituted or substituted; it preferably contains one or more heteroatoms in the ring, preferably from the group consisting of N, O and S; it is preferably an aliphatic heterocyclyl radical having 3 to 7 ring atoms or a heteroaromatic radical having 5 or 6 ring atoms and contains 1, 2 or 3 heteroatoms. The heterocyclic radical can, for example, be a heteroaromatic radical or ring (heteroaryl), such as, for example, a mono-, bi- or polycyclic aromatic system in which at least one ring contains one or more heteroatoms, for example pyridyl, pyrimidinyl, pyridazinyl, pyrazinyl, triazinyl, thienyl, thiazolyl, oxazolyl, furyl, pyrrolyl, pyrazolyl and imidazolyl, or it is a partially or fully hydrogenated radical, such as oxiranyl, oxetanyl, pyrrolidyl, piperidyl, piperazinyl, triazolyl, dioxolanyl, morpholinyl, tetrahydrofuryl. Preference is given to pyrimidinyl and triazinyl. Suitable substituents for a substituted heterocyclic radical are the substituents mentioned further below, and additionally also oxo, for example in the triazolinone radical. The oxo group may also be present at the hetero ring atoms, which may exist in different oxidation states, for example in the case of N and S.

Substituted radicals, such as substituted hydrocarbon radicals, for example substituted alkyl, alkenyl, alkynyl, aryl, phenyl and benzyl, or substituted heterocyclyl or heteroaryl, are, for example, a substituted radical which is derived from an unsubstituted parent compound, where the substituents are, for example, one or more, preferably 1, 2 or 3, radicals from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl and haloalkyl, and unsaturated aliphatic radicals which correspond to the saturated hydrocarbon-containing radicals mentioned, such as alkenyl, alkynyl, alkenyloxy, alkynyloxy, etc. Among the radicals with carbon atoms, preference is given to those having 1 to 4 carbon atoms, in particular 1 or 2 carbon atoms. Preference is generally given to substituents from the group consisting of halogen, for example fluorine and chlorine, (C₁-C₄)-alkyl, preferably methyl or ethyl, (C₁-C₄)-haloalkyl, preferably trifluoromethyl, (C₁-C₄)-alkoxy, preferably methoxy or ethoxy, (C₁-C₄)-haloalkoxy, nitro and cyano. Particular preference is given here to the substituents methyl, methoxy and chlorine.

Optionally substituted phenyl is preferably phenyl which is unsubstituted or mono- or polysubstituted, preferably substituted up to three times, by identical or different radicals, preferably from the group consisting of halogen, (C₁-C₄)-alkyl, (C₁-C₄)-alkoxy, (C₁-C₄)-haloalkyl, (C₁-C₄)-haloalkoxy and nitro, for example o-, m- and p-tolyl, dimethylphenyl, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl. Cycloalkyl is a carbocyclic saturated ring system having preferably 3-6 carbon atoms, for example cyclopropyl, cyclobutyl, cyclopentyl or cyclohexyl.

The carbon skeleton of the carbon-containing radicals, such as alkyl, alkoxy, haloalkyl, haloalkoxy, alkylamino and alkylthio and the corresponding unsaturated and/or substituted radicals may in each case be straight-chain or branched. In these radicals, preference is given to the lower carbon skeletons having, for example, 1 to 6 carbon atoms and, in the case of unsaturated groups, 2 to 6 carbon atoms, unless specified otherwise. Alkyl radicals, also in the composite meanings such as alkoxy, haloalkyl, etc., are, for example, methyl, ethyl, n- or isopropyl, n-, iso-, t- or 2-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals have the meaning of the possible unsaturated radicals which correspond to the alkyl radicals; alkenyl is, for example, allyl, 1-methylprop-2-en-1-yl, 2-methylprop-2-en-1-yl, but-3-en-1-yl, 1-methylbut-3-en-1-yl and 1-methylbut-2-en-1-yl; alkynyl is, for example, propargyl, but-3-yn-1-yl, 1-methylbut-3-yn-1-yl.

Halogen is, for example, fluorine, chlorine, bromine or iodine. Haloalkyl, -alkenyl and -alkynyl is alkyl, alkenyl and alkynyl, respectively, which is partially or fully substituted by halogen, preferably by fluorine, chlorine and/or bromine, in particular by fluorine or chlorine, for example CF₃, CHF₂, CH₂F, CF₃CF₂, CH₂FCHCl, CCl₃, CHCl₂, CH₂CH₂Cl; haloalkoxy is, for example, OCF₃, OCHF₂, OCH₂F, CF₃CF₂O, OCH₂CF₃ and OCH₂CH₂Cl; this applies correspondingly to haloalkenyl and other halogen-substituted radicals.

Within the context of the present invention, the ALS inhibitors contained as component d) in the oil suspension concentrates according to the invention are in each case to be understood as including, in addition to the neutral compounds, also their salts with inorganic and/or organic counterions. Thus, sulfonamides, for example, are capable of forming salts in which the hydrogen of the —SO₂—NH— group is replaced by an agriculturally suitable cation. These salts are, for example, metal salts, in particular alkali metal salts or alkaline earth metal salts, especially sodium and potassium salts, or else ammonium salts or salts with organic amines. Salt formation may also occur by an acid forming an adduct with basic groups, such as, for example, amino and alkylamino. Acids suitable for this purpose are strong inorganic and organic acids, for example HCl, HBr, H₂SO₄ or HNO₃.

Suitable agrochemically active compounds different from component a), which active compounds may be present in the liquid formulations according to the invention as component d), are, preferably, herbicidally active compounds, for example from the group of the carbamates, thiocarbamates, haloacetanilides, substituted phenoxy-, naphthoxy- and phenoxyphenoxycarboxylic acid derivatives, and also heteroaryloxyphenoxyalkanecarboxylic acid derivatives, such as quinolyloxy-, quinoxalyloxy-, pyridyloxy-, benzoxazolyloxy- and benzothiazolyloxyphenoxyalkanecarboxylic acid esters, cyclohexanedione derivatives, phosphorus-containing herbicides, for example of the glufosinate type or of the glyphosate type, and also S—(N-aryl-N-alkylcarbamoylmethyl)dithiophosphoric acid esters.

Preference is given here to phenoxyphenoxy- and heteroaryloxyphenoxycarboxylic acid esters and salts, such as fenoxaprop, and also to herbicides such as bentazone, cyanazine, atrazine, diflufenican, dicamba, 2,4-D, or hydroxybenzonitriles, such as bromoxynil and ioxynil, and other foliar herbicides, for example:
E) herbicides of the type of the phenoxyphenoxy- and heteroaryloxyphenoxycarboxylic acid derivatives, such as
E1) phenoxyphenoxy- and benzyloxyphenoxycarboxylic acid derivatives, for example methyl 2-(4-(2,4-dichlorophenoxy)phenoxy)propionate (diclofop-methyl),
methyl 2-(4-(4-bromo-2-chlorophenoxy)phenoxy)propionate (DE-A 26 01 548),
methyl 2-(4-(4-bromo-2-fluorophenoxy)phenoxy)propionate (U.S. Pat. No. 4,808,750),
methyl 2-(4-(2-chloro-4-trifluoromethylphenoxy)phenoxy)propionate (DE-A 24 33 067),
methyl 2-(4-(2-fluoro-4-trifluoromethylphenoxy)phenoxy)propionate (U.S. Pat. No. 4,808,750),
methyl 2-(4-(2,4-dichlorobenzyl)phenoxy)propionate (DE-A 24 17 487),
ethyl 4-(4-(4-trifluoromethylphenoxy)phenoxy)pent-2-enoate,
methyl 2-(4-(4-trifluoromethylphenoxy)phenoxy)propionate (DE-A 24 33 067);
E2) “monocyclic” heteroaryloxyphenoxyalkanecarboxylic acid derivatives, for example
ethyl 2-(4-(3,5-dichloropyridyl-2-oxy)phenoxy)propionate (EP-A 0 002 925),
propargyl 2-(4-(3,5-dichloropyridyl-2-oxy)phenoxy)propionate (EP-A 0 003 114),
methyl 2-(4-(3-chloro-5-trifluoromethyl-2-pyridyloxy)phenoxy)propionate (EP-A 0 003 890),
ethyl 2-(4-(3-chloro-5-trifluoromethyl-2-pyridyloxy)phenoxy)propionate (EP-A 0 003 890),
propargyl 2-(4-(5-chloro-3-fluoro-2-pyridyloxy)phenoxy)propionate (EP-A 0 191 736),
butyl 2-(4-(5-trifluoromethyl-2-pyridyloxy)phenoxy)propionate (fluazifop-butyl);
E3) “bicyclic” heteroaryloxyphenoxyalkanecarboxylic acid derivatives, for example
methyl and ethyl 2-(4-(6-chloro-2-quinoxalyloxy)phenoxy)propionate (quizalofopmethyl and quizalofopethyl),
methyl 2-(4-(6-fluoro-2-quinoxalyloxy)phenoxy)propionate (see J. Pest. Sci. Vol. 10, 61 (1985)),
2-isopropylideneaminooxyethyl 2-(4-(6-chloro-2-quinoxalyloxy)phenoxy)propionate (propaquizafop),
ethyl 2-(4-(6-chlorobenzothiazol-2-yloxy)phenoxy)propionate (DE-A 26 40 730),
tetrahydro-2-furylmethyl 2-(4-(6-chloroquinoxalyloxy)phenoxy)propionate (EP-A 0 323 727);
F) chloroacetanilides, for example
N-methoxymethyl-2,6-diethylchloroacetanilide (alachlor),
N-(3-methoxyprop-2-yl)-2-methyl-6-ethylchloroacetanilide (metolachlor),
2,6-dimethyl-N-(3-methyl-1,2,4-oxadiazol-5-ylmethyl)chloroacetanilide,
N-(2,6-dimethylphenyl)-N-(1-pyrazolylmethyl)chloroacetamide (metazachlor);
G) thiocarbamates, for example
S-ethyl N,N-dipropylthiocarbamate (EPTC),
S-ethyl N,N-diisobutylthiocarbamate (butylate);
H) cyclohexanedione oximes, for example
methyl 3-(1-allyloxyiminobutyl)-4-hydroxy-6,6-dimethyl-2-oxocyclohex-3-ene-carboxylate (alloxydim),
2-(1-ethoxyiminobutyl)-5-(2-ethylthiopropyl)-3-hydroxycyclohex-2-ene-1-one (sethoxydim),
2-(1-ethoxyiminobutyl)-5-(2-phenylthiopropyl)-3-hydroxycyclohex-2-ene-1-one (cloproxydim),
2-(1-(3-chloroallyloxy)iminobutyl)-5-(2-ethylthiopropyl)-3-hydroxycyclohex-2-ene-1-one,
2-(1-(3-chloroallyloxy)iminopropyl)-5-(2-ethylthiopropyl)-3-hydroxycyclohex-2-ene-1-one (clethodim),
2-(1-ethoxyiminobutyl)-3-hydroxy-5-(thian-3-yl)cyclohex-2-enone (cycloxydim),
2-(1-ethoxyiminopropyl)-5-(2,4,6-trimethylphenyl)-3-hydroxycyclohex-2-ene-1-one (tralkoxydim);
I) benzoylcyclohexanediones, for example
2-(2-chloro-4-methylsulfonylbenzoyl)cyclohexane-1,3-dione (SC-0051, EP-A 0 137 963, sylcotrione), 2-(2-nitrobenzoyl)-4,4-dimethylcyclohexane-1,3-dione (EP-A 0 274 634),
2-(2-nitro-4-methylsulfonylbenzoyl)-4,4-dimethylcyclohexane-1,3-dione (WO 91/13548, mesotrione);
J) S—(N-aryl-N-alkylcarbamoylmethyl) dithiophosphonates, such as S—[N-(4-chlorophenyl)-N-isopropylcarbamoylmethyl] O,O-dimethyl dithiophosphate (anilophos);
K) alkylazines, such as, for example, described in WO-A 97/08156, WO-A-97/31904, DE-A-19826670, WO-A-98/15536, WO-A-98/15537, WO-A-98/15538, WO-A-98/15539 and also DE-A-19828519, WO-A-98/34925, WO-A-98/42684, WO-A-99/18100, WO-A-99/19309, WO-A-99/37627 and WO-A-99/65882, preferably those of the formula (K)

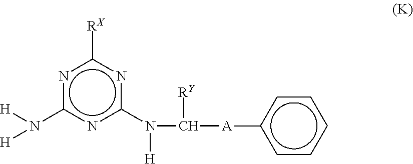

in which
R^{X} is (C₁-C₄)-alkyl or (C₁-C₄)-haloalkyl;
R^{Y} is (C₁-C₄)-alkyl, (C₃-C₆)-cycloalkyl or (C₃-C₆)-cycloalkyl-(C₁-C₄)-alkyl and
A is —CH₂—, —CH₂—CH₂—, —CH₂—CH₂—CH₂—, —O—, —CH₂—CH₂—O—, —CH₂—CH₂—CH₂—O—, particularly preferably those of the formulae K1-K7

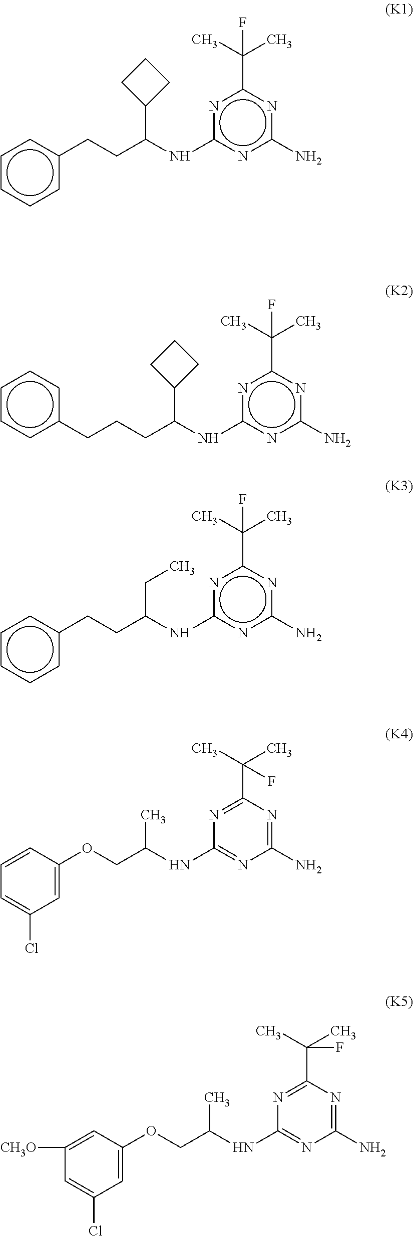

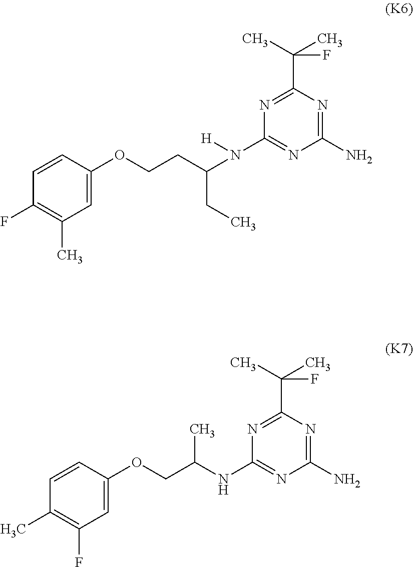

L) Phosphorus-containing herbicides, for example of the glusosinate type, such as glufosinate in a narrower sense, i.e. D,L-2-amino-4-[hydroxy(methyl)phosphinyl]-butanoic acid, glufosinate monoammonium salt, L-glufosinate, L- or (2S)-2-amino-4-[hydroxy(methyl)phosphinyl]butanoic acid, L-glufosinate monoammonium salt or bialaphos (or bilanafos), i.e. L-2-amino-4-[hydroxy(methyl)phosphinyl]butanoyl-L-alanyl-L-alanine, in particular its sodium salt,
   or of the glyphosate type, such as glyphosate, i.e. N-(phosphonomethyl)glycine, glyphosate monoisopropylammonium salt, glyphosate sodium salt or sulfosate, i.e. N-(phosphonomethyl)glycine trimesium salt ═N-(phosphonomethyl)glycine trimethylsulfoxonium salt.

The herbicides of groups E to L are known, for example, from the above-mentioned publications and from “The Pesticide Manual”, 13th edition, 2003, The British Crop Protection Council, “Agricultural Chemicals Book II—Herbicides-”, by W. T. Thompson, Thompson Publications, Fresno Calif., USA 1990 and “Farm Chemicals Handbook '90”, Meister Publishing Company, Willoughby Ohio, USA, 1990.

The liquid formulations according to the invention may additionally also comprise, as optional component d), safeners which are suitable for reducing or preventing damage to the crop plant. Suitable safeners are known, for example, from WO-A-96/14747 and the literature cited therein.

Suitable safeners are, for example, the following groups of compounds:
1) Compounds of the type of dichlorophenylpyrazoline-3-carboxylic acid (S1), preferably compounds such as ethyl 1-(2,4-dichlorophenyl)-5-(ethoxy-carbonyl)-5-methyl-2-pyrazoline-3-carboxylate (S1-1, mefenpyr-diethyl, PM pp. 781-782), and related compounds, as described in WO 91/07874.
2) Derivatives of dichlorophenylpyrazolecarboxylic acid, preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4), ethyl 1-(2,4-dichlorophenyl)-5-phenylpyrazole-3-carboxylate (S1-5) and related compounds, as described in EP-A-333 131 and EP-A-269 806.
3) Compounds of the type of the triazolecarboxylic acids (S1), preferably compounds such as fenchlorazole, i.e. ethyl 1-(2,4-dichlorophenyl)-5-trichloro-methyl-(1H)-1,2,4-triazole-3-carboxylate (S1-6), and related compounds (see EP-A-174 562 and EP-A-346 620).
4) Compounds of the type of the 5-benzyl- or 5-phenyl-2-isoxazoline-3-carboxylic acid, or the 5,5-diphenyl-2-isoxazoline-3-carboxylic acid, preferably compounds such as ethyl 5-(2,4-dichlorobenzyl)-2-isoxazoline-3-carboxylate (S1-7) or ethyl 5-phenyl-2-isoxazoline-3-carboxylate (S1-8) and related compounds, as described in WO 91/08202, or 5,5-diphenyl-2-isoxazolinecarboxylic acid and its ethyl ester (S1-9, isoxadifen-ethyl) or n-propyl ester (S1-10) or ethyl 5-(4-fluorophenyl)-5-phenyl-2-isoxazoline-3-carboxylate (S1-11), as described in the patent application (WO-A-95/07897).
5) Compounds of the type of the 8-quinolineoxyacetic acid (S2), preferably
   1-methylhex-1-yl (5-chloro-8-quinolineoxy)acetate (S2-1, cloquintocet-mexyl, PM pp. 263-264),
   1,3-dimethylbut-1-yl(5-chloro-8-quinolineoxy)acetate (S2-2),
   4-allyloxybutyl (5-chloro-8-quinolineoxy)acetate (S2-3),
   1-allyloxyprop-2-yl(5-chloro-8-quinolineoxy)acetate (S2-4),
   ethyl (5-chloro-8-quinolineoxy)acetate (S2-5),
   methyl (5-chloro-8-quinolineoxy)acetate (S2-6),
   allyl (5-chloro-8-quinolineoxy)acetate (S2-7),
   2-(2-propylideneiminooxy)-1-ethyl (5-chloro-8-quinolineoxy)acetate (S2-8),
   2-oxoprop-1-yl(5-chloro-8-quinolineoxy)acetate (S2-9)
   and related compounds, as described in EP-A-86 750, EP-A-94 349 and EP-A-191 736 or EP-A-0 492 366.
6) Compounds of the type of the (5-chloro-8-quinolineoxy)malonic acid, preferably compounds such as diethyl (5-chloro-8-quinolineoxy)malonate, diallyl (5-chloro-8-quinolineoxy)malonate, methylethyl (5-chloro-8-quinoline-oxy)malonate and related compounds, as described in EP-A-0 582 198.
7) Active compounds of the type of the phenoxyacetic or -propionic acid derivatives or the aromatic carboxylic acids, such as, for example, 2,4-dichlorophenoxyacetic acid (esters) (2,4-D), 4-chloro-2-methylphenoxy-propionic esters (mecoprop), MCPA or 3,6-dichloro-2-methoxybenzoic acid (esters) (dicamba).
8) Active compounds of the type of the pyrimidines, such as “fenclorim” (PM, pp. 512-511) (=4,6-dichloro-2-phenylpyrimidine).
9) Active compounds of the type of the dichloroacetamides, which are frequently used as pre-emergence safeners (soil-acting safeners), such as, for example,
   “dichlormid” (PM, pp. 363-364 (═N,N-diallyl-2,2-dichloroacetamide),
   “R-29148” (=3-dichloroacetyl-2,2,5-trimethyl-1,3-oxazolidone from Stauffer),
   “benoxacor” (PM, pp. 102-103) (=4-dichloroacetyl-3,4-dihydro-3-methyl-2H-1,4-benzoxazine),
   “PPG-1292” (═N-allyl-N-[(1,3-dioxolan-2-yl)methyl]dichloroacetamide from PPG Industries),
   “DK-24” (═N-allyl-N—[(allylaminocarbonyl)methyl]dichloroacetamide from Sagro-Chem),
   “AD-67” or “MON 4660” (=3-dichloroacetyl-1-oxa-3-azaspiro[4,5]decane from Nitrokemia or Monsanto),
   “diclonon” or “BAS145138” or “LAB145138” (=3-dichloroacetyl-2,5,5-tri-methyl-1,3-diazabicyclo[4.3.0]nonane from BASF) and
   “furilazol” or “MON 13900” (see PM, 637-638) (═(RS)-3-dichloroacetyl-5-(2-furyl)-2,2-dimethyloxazolidone).
10) Active compounds of the type of the dichloroacetone derivatives, such as, for example,
“MG 191” (CAS-Reg. No. 96420-72-3) (=2-dichloromethyl-2-methyl-1,3-dioxolane from Nitrokemia).
11) Active compounds of the type of the oxyimino compounds, which are known as seed dressings, such as, for example,
   “oxabetrinil” (PM, pp. 902-903) (═(Z)-1,3-dioxolan-2-ylmethoxyimino-(phenyl)acetonitrile), which is known as seed dressing safener against metolachlor damage,
   “fluxofenim” (PM, pp. 613-614) (=1-(4-chlorophenyl)-2,2,2-trifluoro-1-ethanone O-(1,3-dioxolan-2-ylmethyl) oxime which is known as seed dressing safener against metolachlor damage, and
   “cyometrinil” or “CGA-43089” (PM, p. 1304) (═(Z)-cyanomethoxyimino-(phenyl)acetonitrile), which is known as seed dressing safener against metolachlor damage.
12) Active compounds of the type of the thiazolecarboxylic esters, which are known as seed dressings, such as, for example,
   “flurazole” (PM, pp. 590-591) (=benzyl 2-chloro-4-trifluoromethyl-1,3-thiazole-5-carboxylate), which is known as seed dressing safener against alachlor and metolachlor damage.
13) Active compounds of the type of the naphthalenedicarboxylic acid derivatives, which are known as seed dressings, such as, for example,
   “naphthalic anhydride” (PM, p. 1342) (=1,8-naphthalenedicarboxylic anhydride), which is known as seed dressing safener for corn against thiocarbamate herbicide damage.
14) Active compounds of the type of the chromanacetic acid derivatives, such as, for example,
   “CL 304415” (CAS-Reg. No. 31541-57-8) (=2-(4-carboxychroman-4-yl)acetic acid from American Cyanamid).
15) Active compounds which, in addition to a herbicidal action against harmful plants, also have safener action on crop plants such as, for example,
   “dimepiperate” or “MY-93” (PM, pp. 404-405) (═S-1-methyl-1-phenylethyl piperidine-1-thiocarboxylate),
   “daimuron” or “SK 23” (PM, p. 330) (=1-(1-methyl-1-phenylethyl)-3-p-tolyl-urea),
   “cumyluron”=“JC-940” (=3-(2-chlorophenylmethyl)-1-(1-methyl-1-phenyl-ethyl)urea, see JP-A-60087254),
   “methoxyphenone” or “NK 049” (=3,3′-dimethyl-4-methoxybenzophenone),
   “CSB” (=1-bromo-4-(chloromethylsulfonyl)benzene) (CAS-Reg. No. 54091-06-4 from Kumiai).

Compounds of the type of the acylsulfamoylbenzamides, for example of the formula (S3) below, which are known, for example, from WO 99/16744.

(S3)

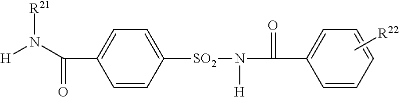

| Compound no. | R²¹ | R²² |
|---|---|---|
| S3-1 | cyclopropyl | 2-OCH₃ |
| S3-2 | cyclopropyl | 2-OCH₃, 5-Cl |
| S3-3 | ethyl | 2-OCH₃ |
| S3-4 | isopropyl | 2-OCH₃, 5-Cl |
| S3-5 | isopropyl | 2-OCH₃ |

Preferred safeners are mefenpyr, fenchlorazole, isoxadifen, cloquintocet, and their C₁-C₁₀-alkyl esters, and also the safeners (S3-1), (S3-5), benoxacor (S-4) and cyprosulfamide.

Very particularly preferred safeners are mefenpyr-diethyl (S1-1), fenchlorazole-ethyl (S1-6), isoxadifen-ethyl (S1-9), cloquintocet-mexyl (S2-1), (S3-1), (S3-5).

If the liquid formulations according to the invention comprise additional active compounds and safeners according to component d), their proportion by weight is generally from 0 to 50% by weight, in particular from 1 to 30% by weight. Here, the safeners, like the active compounds, may be present in dissolved form or in at least partially undissolved form.

The total active compound content present in the liquid formulations according to the invention (i.e. the sum of the components a)+d)) is generally between 1 and 80% by weight, preferably between 2 and 53% by weight.

Customary auxiliaries and additives according to component e) which may also be present in the liquid formulations according to the invention are, for example: surfactants, such as emulsifiers and dispersants, thickeners and thixotropic agents, adjuvants, wetting agents, anti-drift agents, adhesives, penetrants, preservatives and antifreeze agents, stabilizers, antioxidants, solubilizers, fillers, carriers and colorants, antifoams, fertilizers, evaporation inhibitors and agents which modify pH and viscosity.

Suitable emulsifiers and dispersants are, for example, nonionic emulsifiers and dispersants, for example:
1) polyalkoxylated, preferably polyethoxylated, saturated and unsaturated aliphatic alcohols,
   having 8 to 24 carbon atoms in the alkyl radical, which is derived from the corresponding fatty acids or from petrochemical products, and
   having 1 to 100, preferably 2 to 50, ethylene oxide units (EO), it being possible for the free hydroxyl group to be alkoxylated,
   which are commercially available, for example as Genapol® X and Genapol® O series (Clariant), Crovol® M series (Croda) or as Lutensol® series (BASF), or are obtainable therefrom by etherification, for example Genapol®X060 methyl ether,
2) polyalkoxylated, preferably polyethoxylated, arylalkylphenols, such as, for example, 2,4,6-tris(1-phenylethyl)phenol (tristyrylphenol) having an average degree of ethoxylation of between 10 and 80, preferably from 16 to 40, such as, for example SOPROPHOR® BSU (RHODIA) or HOE S 3474 (CLARIANT),
3) polyalkoxylated, preferably polyethoxylated, alkylphenols having one or more alkyl radicals, such as, for example, nonylphenol or tri-sec-butylphenol, and a degree of ethoxylation of between 2 and 40, preferably from 4 to 15, such as, for example, ARKOPAL® N series or APOGENAT® T series (CLARIANT),
4) polyalkoxylated, preferably polyethoxylated, hydroxyfatty acids or glycerides which contain hydroxyfatty acids, such as, for example, ricinine or castor oil, having a degree of ethoxylation of between 10 and 80, preferably from 25 to 40, such as, for example, the EMULSOGEN® EL series (CLARIANT) or the AGNIQUE® CSO series (COGNIS),
5) polyalkoxylated, preferably polyethoxylated, sorbitan esters, such as, for example, Atplus® 309 F (UNIQEMA) or the Alkamuls® series (Rhodia),
6) di- and tri-block copolymers, for example from alkylene oxides, for example from ethylene oxide and propylene oxide, having average molar masses between 200 and 10 000, preferably from 1000 to 4000, g/mol, the proportion by mass of the polyethoxylated block varying between 10 and 80%, such as, for example, the GENAPOL® PF series (CLARIANT), the PLURONIC® series (BASF), or the SYNPERONIC® PE series (UNIQEMA).

Preferred nonionic emulsifiers and dispersants are, for example, polyethoxylated alcohols, polyethoxylated triglycerides which contain hydroxyfatty acids and polyethylene oxide/polypropylene oxide block copolymers.

The total proportion of nonionic emulsifiers and dispersants in the oil suspension concentrates according to the invention is generally between 0 and 40% by weight, preferably between 1 and 30% by weight.

If nonionic emulsifiers and dispersants are, in addition to their emulsifying/dispersing properties, also used for increasing the biological effectiveness, for example as penetrants or adhesives, their proportion in the oil suspension concentrates according to the invention can be increased to up to 60% by weight.

Also suitable are ionic emulsifiers and dispersants, for example:
1) polyalkoxylated, preferably polyethoxylated, emulsifiers/dispersants (cf. component e) which are ionically modified, for example by conversion of the terminal free hydroxyl function of the polyethylene oxide block into a sulfate or phosphate ester (for example as alkali metal and alkaline earth metal salts), such as, for example, Genapol® LRO or dispersant 3618 (Clariant), Emulphor® (BASF) or Crafol® AP (Cognis),
2) alkali metal and alkaline earth metal salts of alkylarylsulfonic acids having a straight-chain or branched alkyl chain, such as phenylsulfonate CA or phenylsulfonate CAL (Clariant), Atlox® 3377BM (ICI), or the Empiphos® TM series (Huntsman),
3) polyelectrolytes, such as lignosulfonates, condensates of naphthalenesulfonate and formaldehyde, polystyrenesulfonate or sulfonated unsaturated or aromatic polymers (polystyrenes, polybutadienes or polyterpenes), such as the Tamol® series (BASF), Morwet® D425 (Witco), the Kraftsperse® series (Westvaco) or the Borresperse® series (Borregard).

Preferred ionic emulsifiers/dispersants are, for example, salts of alkylarylsulfonic acids and polyelectrolytes from the polycondensation of naphthalenesulfonate and formaldehyde.

The total proportion of ionic emulsifiers and dispersants in the oil suspension concentrates according to the invention is generally between 0 and 20% by weight, in particular between 0 and 8% by weight.

Suitable thickeners and thixotropic agents are, for example:
1) modified natural silicates, such as chemically modified bentonites, hectorites, attapulgites, montmorillonites, smectites or other silicate minerals, such as BENTONE® (ELEMENTIS), ATTAGEL® (ENGELHARD), AGSORB® (OIL-DRI CORPORATION) or HECTORITE® (AKZO NOBEL),
2) synthetic silicates, such as silicates of the SIPERNAT®, AEROSIL® or DUROSIL® series (DEGUSSA), the CAB-O-SIL® series (CABOT) or the VAN GEL series (R.T. VANDERBILT),
3) thickeners based on synthetic polymers, such as thickeners of the Thixin® or THIXATROL® series (ELEMENTIS),
4) thickeners based on natural polymers and natural oils, for example from the THIXIN Or THIXATROL® series (ELEMENTIS).

Preferred thickeners and thixotropic agents are, for example, modified phyllosilicates and thickeners based on synthetic polymers.

The proportion of thickeners and thixotropic agents in the oil suspension concentrates according to the invention is generally between 0 and 5% by weight, in particular between 0.2 and 4% by weight.

Suitable adjuvants are, for example, fatty acid esters, for example of natural origin, for example natural oils, such as animal oils or vegetable oils, or of synthetic origin, for example the Edenor® series, for example Edenor® MEPa or Edenor® MESU, or the AGNIQUE® ME series or AGNIQUE® AE series (COGNIS), the SALIM® ME series (SALIM), the Radia® series, for example Radia® 30167 (ICI), the Prilube® series, for example Prilube® 1530 (Petrofina), the STEPAN® C series (STEPAN) or the WITCONOL® 23 series (WITCO). The fatty acid esters are preferably esters of C₁₀-C₂₂-, with preference C₁₂-C₂₀-, fatty acids. The C₁₀-C₂₂-fatty acid esters are, for example, esters of unsaturated or saturated C₁₀-C₂₂-fatty acids, in particular those having an even number of carbons, for example erucic acid, lauric acid, palmitic acid, and in particular C₁₈-fatty acids, such as stearic acid, oleic acid, linoleic acid or linolenic acid.

Examples of fatty acid esters such as C₁₀-C₂₂-fatty acid esters are glycerol and glycol esters of fatty acids such as C₁₀-C₂₂-fatty acids, or transesterification products thereof, for example fatty acid alkyl esters such as C₁₀-C₂₂-fatty acid C₁-C₂₀-alkyl esters, which can be obtained, for example, by transesterification of the abovementioned glycerol or glycol fatty acid esters such as C₁₀-C₂₂-fatty acid esters with C₁-C₂₀-alcohols (for example methanol, ethanol, propanol or butanol). The transesterification can be carried out by known methods, as described, for example, in Römpp Chemie Lexikon, 9th edition, volume 2, page 1343, Thieme Verlag Stuttgart.

Preferred fatty acid alkyl esters such as C₁₀-C₂₂-fatty acid C₁-C₂₀-alkyl esters are methyl esters, ethyl esters, propyl esters, butyl esters, 2-ethylhexyl esters and dodecyl esters. Preferred glycol and glycerol fatty esters such as C₁₀-C₂₂-fatty acid esters are the uniform or mixed glycol esters and glycerol esters of C₁₀-C₂₂-fatty acids, in particular of such fatty acids having an even number of carbon atoms, for example erucic acid, lauric acid, palmitic acid and in particular C₁₈-fatty acids such as stearic acid, oleic acid, linoleic acid or linolenic acid.

Animal oils b) are generally known and commercially available. For the purpose of the present invention, the term “animal oils” is to be understood as meaning, for example, oils of animal origin such as whale oil, cod-liver oil, musk oil or mink oil.

Vegetable oils b) are generally known and commercially available. For the purpose of the present invention, the term “vegetable oils” is to be understood as meaning, for example, oils of oleaginous plant species, such as soybean oil, rapeseed oil, corn oil, sunflower oil, cottonseed oil, linseed oil, coconut oil, palm oil, thistle oil, walnut oil, arachis oil, olive oil or castor oil, in particular rapeseed oil, where the vegetable oils also include their transesterification products, for example alkyl esters, such as rapeseed oil methyl ester or rapeseed oil ethyl ester.

The vegetable oils are preferably esters of C₁₀-C₂₂-, preferably C₁₂-C₂₀-, fatty acids. The C₁₀-C₂₂-fatty acid esters are, for example, esters of unsaturated or saturated C₁₀-C₂₂-fatty acids having, in particular, an even number of carbon atoms, for example erucic acid, lauric acid, palmitic acid and in particular, C₁₈-fatty acids such as stearic acid, oleic acid, linoleic acid or linolenic acid.

Examples of vegetable oils are C₁₀-C₂₂-fatty acid esters of glycerol or glycol with C₁₀-C₂₂-fatty acids, or C₁₀-C₂₂-fatty acid C₁-C₂₀-alkyl esters which can be obtained, for example, by transesterification of the glycerol or glycol C₁₀-C₂₂-fatty acid esters mentioned above with C₁-C₂₀-alcohols (for example methanol, ethanol, propanol or butanol). The transesterification can be carried out by known methods as described, for example, in Römpp Chemie Lexikon, 9th edition, volume 2, page 1343, Thieme Verlag Stuttgart.

The vegetable oils can be contained in the oil suspension concentrates according to the invention for example in the form of commercially available vegetable oils, in particular rapeseed oils, such as rapeseed oil methyl ester, for example Phytorob® B (Novance, France), Edenor® MESU and the Agnique® ME series (Cognis, Germany), the Radia® series (ICI), the Prilube® series (Petrofina), or biodiesel or in the form of commercially available, plant-oil-containing formulation additives, in particular those based on rapeseed oils, such as rapeseed oil methyl esters, for example Hasten® (Victorian Chemical Company, Australia, hereinbelow referred to as Hasten, main ingredient: rapeseed oil ethyl ester), Actirob® B (Novance, France, hereinbelow referred to as ActirobB, main ingredient: rapeseed oil methyl ester), Rako-Binol® (Bayer AG, Germany, hereinbelow referred to as Rako-Binol, main ingredient: rapeseed oil), Renol® (Stefes, Germany, hereinbelow referred to as Renol, vegetable oil ingredient: rapeseed oil methyl ester) or Stefes Mero® (Stefes, Germany, hereinbelow referred to as Mero, main ingredient: rapeseed oil methyl ester).

Examples of synthetic fatty acid esters are, for example, those derived from fatty acids having an odd number of carbon atoms, such as C₁₁-C₂₁-fatty acid esters.

The proportion of adjuvants such as fatty acid esters in the liquid formulations according to the invention is generally between 0 and 75% by weight, preferably between 5 and 20% by weight.

As optional component f), the formulations according to the invention may also comprise tank mix components. Examples of these are tank mix adjuvants such as Telmion® or esterified vegetable oils such as Actirob® (Novance) or Hasten® (Victorian Chemicals), inorganic compounds such as ammonium sulphate, ammonium nitrate and fertilizers or hydrotropics.

### Preparation of the Formulations

The formulations according to the invention can be prepared by known processes, for example by mixing the components. Thus, for example, it is possible to initially charge component b) (non-polar hydrocarbon) and to add the further components. It is also possible, if appropriate, to mix component b) with a thickener prior to the addition of the other components. The resulting oil suspension can then, if appropriate after pregrinding, be subjected to fine grinding.

To prepare the mixtures, it is possible to use customary mixing apparatus which, if required, are thermostatted. For pregrinding, it is possible to use, for example, high-pressure homogenizers or mills operating by the rotor-stator principle, such as Ultraturrax homogenizers, for example those from IKA, or toothed colloid mills, for example from Puck. For fine grinding, it is possible to use, for example, bead mills which operate batch-wise, for example from Drais, or bead mills which operate continuously, for example from Bachofen. The preparation process can be adapted to the properties of the components employed and to technical and safety requirements and to economical considerations, and pregrinding and even fine grinding may be dispensed with, if required.

The components a) to f) used for the preparation may comprise water as a minor component which is also found in the oil suspension concentrates according to the invention. Accordingly, the emulsion concentrates (EC) according to the invention may comprise small amounts of water, in general from 0 to 5% by weight.

### Application

For application, the oil suspension concentrates according to the invention may, if required, be diluted in a customary manner using, for example, water, to give, for example, emulsions, suspensions, suspoemulsions or solutions.

It may be advantageous to add further agrochemically active compounds (for example tank mix components in the form of appropriate formulations) and/or auxiliaries and additives customary for application, for example self-emulsifying oils, such as vegetable oils or paraffin oils, and/or fertilizers to the spray liquors obtained. Accordingly, the present invention also provides such liquid herbicidal compositions obtainable by diluting the emulsion concentrates (EC) according to the invention.

The herbicidal compositions according to the invention (hereinbelow in each case also comprising the emulsion concentrates (EC) according to the invention) have outstanding herbicidal activity against a broad spectrum of economically important monocotyledonous and dicotyledonous harmful plants. Even perennial weeds which produce shoots from rhizomes, rootstocks or other perennial organs and which are difficult to control are controlled well. In this context, it does not matter whether the substances are applied before sowing, pre-emergence or post-emergence. Specific examples may be mentioned of some representatives of the monocotyledonous and dicotyledonous weed flora which can be controlled by the herbicidal compositions according to the invention, without the enumeration being a restriction to certain species.

Examples of weed species on which the herbicidal compositions act efficiently are, from amongst the monocotyledonous weed species, Apera spica venti, Avena spp., Alopecurus spp., Brachiaria spp., Digitaria spp., Lolium spp., Echinochloa spp., Panicum spp., Phalaris spp., Poa spp., Setaria spp. and Bromus spp. such as Bromus catharticus, Bromus secalinus, Bromus erectus, Bromus tectorum and Bromus japonicus, and Cyperus species from the annual group, and, among the perennial species, Agropyron, Cynodon, Imperata and Sorghum and also perennial Cyperus species.

In the case of the dicotyledonous weed species, the spectrum of action extends to species such as, for example, Abutilon spp., Amaranthus spp., Chenopodium spp., Chrysanthemum spp., Galium spp. such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., among the annuals, and Convolvulus, Cirsium, Rumex and Artemisia in the case of the perennial weeds.

The compositions according to the invention also act outstandingly efficiently on harmful plants which are found under the specific cultures in rice, such as, for example, Echinochloa, Sagittaria, Alisma, Eleocharis, Scirpus and Cyperus.

If the herbicidal compositions according to the invention are applied to the soil surface before germination, the weed seedlings are either prevented completely from emerging or else the weeds grow until they have reached the cotyledon stage, but then their growth stops, and, eventually, after three to four weeks have elapsed, they die completely.

If the herbicidal compositions according to the invention are applied post-emergence to the green parts of the plants, growth likewise stops drastically a very short time after the treatment, and the weed plants remain at the growth stage at the point of time of application, or they die completely after a certain time, so that in this manner competition by the weeds, which is harmful to the crop plants, is eliminated very early and in a sustained manner.

The herbicidal compositions according to the invention are distinguished by a rapidly commencing and long-lasting herbicidal action. As a rule, the rainfastness of the active compounds in the herbicidal compositions according to the invention is advantageous. A particular advantage is that the dosages used in the herbicidal compositions and the effective dosages of herbicidal compounds can be adjusted to such a low level that their soil action is optimally low. This does not only allow them to be employed in sensitive crops in the first place, but groundwater contaminations are virtually avoided. The active compound combination according to the invention allows the required application rate of the active compounds to be reduced considerably.

The abovementioned properties and advantages are necessary for weed control practice to keep agricultural crops free from undesired competing plants, and thus to ensure and/or increase yield levels from the qualitative and quantitative angle. These novel compositions markedly exceed the technical state of the art with a view to the properties described.

While the herbicidal compositions according to the invention have an outstanding herbicidal activity against monocotyledonous and dicotyledonous weeds, crop plants of economically important crops, for example dicotyledonous crops such as soya, cotton, oilseed rape, sugar beet, or graminaceous crops such as wheat, barley, rye, oats, millet, rice or corn, are damaged only to a minor extent, if at all. This is why the present compounds are highly suitable for the selective control of undesired plant growth in plantations of agricultural crops or of ornamentals.

In addition, the herbicidal compositions according to the invention have outstanding growth-regulatory properties in crop plants. They engage in the plants' metabolism in a regulatory manner and can thus be employed for provoking direct effects on plant constituents and to facilitate harvesting such as, for example, by triggering desiccation and stunted growth. Moreover, they are also suitable for the general control and inhibition of undesired vegetative growth without simultaneously destroying the plants. Inhibition of vegetative growth is very important in a large number of monocotyledonous and dicotyledonous crops since lodging can thus be reduced, or prevented completely.

Owing to their herbicidal and plant-growth-regulatory properties, the herbicidal compositions according to the invention can also be employed for controlling harmful plants in crops of genetically modified plants which are known or yet to be developed. As a rule, the recombinant plants are distinguished by specific advantageous characteristics, for example by resistances to certain pesticides, in particular certain herbicides, resistances to plant diseases or the causative organisms of plant diseases such as specific insects or microorganisms such as fungi, bacteria or viruses. Other specific characteristics relate, for example, to the harvested material with regard to quantity, quality, storability, composition and specific constituents. Thus, for example, transgenic plants are known whose starch content is increased, or whose starch quality is altered, or those where the harvested material has a different fatty acid composition.

The use of the compositions according to the invention in economically important transgenic crops of useful plants and ornamentals, for example of graminaceous crops such as wheat, barley, rye, oats, millet, rice and corn, or else crops of sugar beet, cotton, soya, oilseed rape, potatoes, tomatoes, peas and other vegetables, is preferred. Preferably, the compositions according to the invention can be employed as herbicides in crops of useful plants which resist the phytotoxic effects of the herbicides, or have been made to resist these effects by recombinant techniques.

When using the herbicidal compositions according to the invention in transgenic crops, effects are frequently observed in addition to the effects against harmful plants to be observed in other crops, which are specific for the application in the transgenic crop in question, for example a modified or specifically widened weed spectrum which can be controlled, modified application rates which may be employed for application, preferably good combining ability with the herbicides to which the transgenic crop is resistant, and an effect on growth and yield level of the transgenic crop plants.

The present invention furthermore also relates to a method for controlling unwanted vegetation, (for example harmful plants such as monocotyledonous or dicotyledonous weeds or unwanted crop plants) preferably in crops of plants such as cereals (for example wheat, barley, rye, oats, rice, corn and millet), sugar beet, sugar cane, oilseed rape, cotton and soya, especially preferred in monocotyledonous crops such as cereals, for example wheat, barley, rye, oats, and their hybrids such as triticale, rice, corn and millet, where one or more herbicidal compositions according to the invention are applied to the plants (for example harmful plants), plant parts, the need (for example seeds of the plants) or the area on which the plants grow (for example the area under cultivation).

The plant crops may also be genetically modified or have been obtained by mutation selection; they preferably tolerate acetolactate synthase (ALS) inhibitors.

The emulsion concentrate of the present invention has excellent chemical stability during preparation and storage and is suitable in particular also for combinations of active compounds having different physicochemical properties. Moreover, the oil suspension concentrate has excellent physical stability, is easy to apply and easy to use and has high biological effectiveness and selectivity.

### EXAMPLES

The examples below are only meant to illustrate the invention without having any limiting character.

### I. Formulation Examples

Comparison of the active compound stability as a function of the solvent with identical basic formulation, where the basic formulation in formulation example A comprises the detergent Triton GR 7 ME and, in contrast, the basic formulation in formulation example B does not comprise this detergent.

The solvents used were α) Solvesso 200, β) Hallcomid M 8/10, γ) tetrahydrofurfuryl alcohol (THF), δ) propylene carbonate and ε) dimethylformamide (DMF).

The active compound stability of the formulation was determined by comparing the initial active compound content of the respective formulation with the active compound content of the same formulation after two weeks of storage at 54° C. The degradation in percent is in each case stated in the last column of Table 1 and Table 2.

### Formulation Example A

Basic formulation:

| | |
|---|---|
| 2.0% | active compound |
| 3.0% | Emulsogen EL 400 |
| 2.0% | Emcol P18.60 |
| 10.0% | Genapol V 4739 |
| 10.0% | Triton GR 7 ME |
| 73.0% | solvent α), β), γ), δ) or ε) |

TABLE 1

| | Active | | Initial content | Content after | Degradation |
|---|---|---|---|---|---|
| Ex. | compound | Solvent | [%] | 2 W/54° C. [%] | [%] |
| A1 | iodo- | α) Solvesso 200 | 1.97 | 1.56 | −21 |
| | sulfuron | β) Hallcomid M 8/10 | 1.91 | 0.41 | −78 |
| | | γ) THF | 1.92 | 0.51 | −73 |
| | | δ) propylene | 1.93 | 0.32 | −84 |
| | | carbonate | | | |
| | | ε) DMF | 1.92 | 0.13 | −93 |
| A2 | compound | α) Solvesso 200 | 1.96 | 1.87 | −4.6 |
| | formula (I) | β) Hallcomid M 8/10 | 1.93 | 0.99 | −49 |
| | (Na salt) | γ) THF | 1.89 | 0.86 | −55 |
| | | δ) propylene | 1.98 | 1.02 | −49 |
| | | carbonate | | | |
| | | ε) DMF | 1.85 | 0.47 | −75 |
| A3 | compound | α) Solvesso 200 | 0.60 | 0.01 | −98 |
| | formula (I) | β) Hallcomid M 8/10 | 0.39 | 0.01 | −98 |
| | (neutral | γ) THF | 0.51 | 0.01 | −99 |
| | compound) | δ) propylene | 0.25 | 0.01 | −98 |
| | | carbonate | | | |
| | | ε) DMF | 0.25 | 0.01 | −98 |

The data of Examples A1 in Table 1 show the effect of the different solvents α), β), γ), δ) and ε) on the stability of the comparative substance iodosulfuron. For the solvents β), γ), δ) and ε), the degradation is more than 70%, whereas the degradation for the solvent α) is just above 20%.

For the compound of the formula (I) (Examples A2), the degradation when the solvent α) Solvesso 200 is used is 4.6% (Example A2α). Surprisingly, the degradation in all other solvents, even in the most favorable cases, i.e. in A2β and A2δ, is more than 10 times higher compared to Example A2α.

The measurements for Examples A3 in Table 1 relate to the neutral compound of the formula (I), i.e. their acid. Surprisingly, the degradation for all solvents is 98% or even 99%, which corresponds to a quantitative degradation of the compound in this solvent.

Thus, the measurement of Examples A3 in Table 1 show that the degradation measured for Examples A1α and A2α, i.e. the effect originating from the solvent α) Solvesso 200 on the stability of the active compound, is not subject to a general predictable tendency which would be observable for any active compound.

### Formulation Example B

Basic formulation:

| | |
|---|---|
| 2.0% | active compound |
| 3.0% | Emulsogen EL 400 |
| 2.0% | Emcol P 18.60 |
| 10.0% | Genapol V 4739 |
| 83.0% | solvent α), β), γ), δ) or ε) |

TABLE 2

| | Active | | Initial content | Content after | Degradation |
|---|---|---|---|---|---|
| Ex. | compound | Solvent | [%] | 2 W/54° C. [%] | [%] |
| B1 | iodo- | α) Solvesso 200 | 1.44 | 0.73 | −49 |
| | sulfuron | β) Hallcomid M 8/10 | 1.85 | 0.02 | −99 |
| | | γ) THF | 1.74 | 0.26 | −85 |
| | | δ) propylene | 1.60 | 0.00 | −100 |
| | | carbonate | | | |
| | | ε) DMF | 1.74 | 0.01 | −99 |
| B2 | compound | α) Solvesso 200 | 2.06 | 1.97 | −4.4 |
| | formula (I) | β) Hallcomid M 8/10 | 1.93 | 0.32 | −83 |
| | (Na salt) | γ) THF | 1.82 | 0.49 | −73 |
| | | δ) propylene | 1.70 | 0.90 | −47 |
| | | carbonate | | | |
| | | ε) DMF | 1.93 | 0.35 | −82 |
| B3 | compound | α) Solvesso 200 | 0.06 | 0.01 | −17 |
| | formula (I) | β) Hallcomid M 8/10 | 0.34 | 0.00 | −100 |
| | (neutral | γ) THF | 0.68 | 0.00 | −100 |
| | compound) | δ) propylene | 0.25 | 0.00 | −100 |
| | | carbonate | | | |
| | | ε) DMF | 0.87 | 0.09 | −90 |

DMF = dimethylformamide
THF = tetrahydrofurfuryl alcohol

The data of Table 2 summarize the active compound degradation in various formulations, where none of the formulations prepared with solvents α), β), γ), δ) and ε), repectively, comprises Triton GR 7 ME.

The data of Examples B1 in Table 2 show the stability for the comparative active compound iodosulfuron. Iodosulfuron is relatively stable in solvent α) compared to the other solvents; however, in absolute terms the active compound degradation in Example B1α is unacceptably high at 49%.

According to Example B2α, the degradation for the compound of the formula (I) in a formulation with the solvent α) Solvesso 200 is, at only 4.4%, even lower than in the corresponding Formulation Examples A (see Table 1).

This additional improvement in Formulation Example B2α (compared to A2α) is, in view of the markedly worse active compound stability in Formulation Examples B compared to the Formulation Examples A (with the two exceptions B3α and B3ε which, in absolute terms, still have an unacceptably high degradation), surprising.

Thus, the measurements of Examples 3B confirm that the low active compound degradation demonstrated for Examples A1α and B1α is not due to the action of a detergent such as, for example, Triton GR 7 ME, but only on the presence as a non-polar organic solvent, i.e., for example, that of the solvent Solvesso 200.

Furthermore, the measurements of Examples 3B demonstrate that the surprisingly improved active compound stability of a compound of the formula (I) in the presence of a non-polar organic solvent does not in any way correspond to a general property, i.e. a property which can be predicted for different active compounds. Thus, for example, THF, which is mentioned in the prior art as a solvent which is particularly suitable for the formulation of sulfonylureas, is on the contrary unsuitable for formulating the compounds of the formula (I).

### II. Biological Examples

### Preparation of the Spray Liquors

An application rate of 300 l of water/ha was initially charged. The herbicide and, if appropriate, additives were then added with stirring according to the statements made in Table 3. The mixture was stirred until a homogenous spray liquor had formed.

For comparison, the compound of the formula (I) was employed in two different formulation forms. Firstly, 20% by weight of the compound of the formula (I) were employed as a water-dispersible powder, and secondly the compound of the formula (I) was employed as an emulsion concentrate having an active compound content of 20 g/l.

### Biological Tests

Plant seeds were sown at a depth of up to 0.5 cm and cultivated in a climatized chamber (12 h of light, temperature day: 18° C., night: 14° C.) to a growth stage of one or two leaves.

The plants were treated on a laboratory track sprayer with the spray liquors in question. The application rate for the spray application was 300 l of water/ha. After the treatment, the plants were returned to the climatized chamber.

### Efficacy Assessment and Evaluation

21 days after the application, the efficacy of the various formulations against the weeds was assessed on a scale of from 0 to 100%:
0%=no noticable effect compared to untreated plants
100%=all plants have been killed.

The evaluation of the biological tests gave the results summarized in Table 3 below.

TABLE 3

| | Dosage | | | | | |
|---|---|---|---|---|---|---|
| | [g of | | | | | |
| Components | a.i./ha] | ALOMY | MATIN | VERPE | VIOTR | Mean |
| Na salt of the | 20 | 97 | 85 | 75 | 85 | 85.5 |
| compound | | | | | | |
| of the | | | | | | |
| formula (I) | | | | | | |
| as WP | | | | | | |
| formulation* | | | | | | |
| Na salt of the | 20 | 99 | 90 | 85 | 90 | 91 |
| compound | | | | | | |
| of the | | | | | | |
| formula (I) | | | | | | |
| as EC- | | | | | | |
| formulation | | | | | | |

*for the formulation made from water-dispersible powder (WP formulation), 2 I of ActirobB/ha were added to the spray liquor

The results summerized in Table 3 confirm a markedly improved efficacy for the active compound of the formula (I) formulated as emulsion concentrate. When the means are compared (see last column of Table 3) it is found that the efficacy improvement compared to a formulation of water-dispersible powder (WP formulation) of the same active compound is more than 5%.

The efficacy of a 1 l/ha EC finished formulation is markedly higher than the efficacy of the tank mix prepared from water-dispersible powder (WP) with addition of 2 l of ActirobB/ha.

The abbreviations used above denote:
g of a.i./ha=gram of active substance/hectare
l/ha=liter/hectare
WP=water-dispersible powder
EC=emulsion concentrate
ALOMY=Alopecurus myosuroides
MATIN=Matricaria inodora
VERPE=Veronica persica
VIOTR=Viola tricolor

1. A liquid formulation comprising
a) at least one agrochemically active salt of 2-iodo-N-[(4-methoxy-6-methyl-1,3,5-triazin-2-yl)carbamoyl]benzenesulfonamide of formula (I), 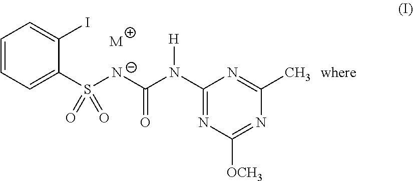
the cation M⁺ is
(i) an alkali metal ion, or
(ii) an alkaline earth metal ion, or
(iii) a transition metal ion, or
(iv) an ammonium ion where optionally one, two, three or four hydrogen atoms are substituted by identical or different radicals from the group consisting of (C₁-C₄)-alkyl, hydroxy-(C₁-C₄)-alkyl, (C₃-C₆)-cycloalkyl, (C₁-C₄)-alkoxy-(C₁-C₄)-alkyl, hydroxy-(C₁-C₄)-alkoxy-(C₁-C₄)-alkyl, (C₁-C₆)-mercaptoalkyl, phenyl and benzyl, where the radicals mentioned above are optionally substituted by one or more identical or different radicals from the group consisting of halogen, nitro, cyano, azido, (C₁-C₆)-alkyl, (C₁-C₆)-haloalkyl, (C₃-C₆)-cycloalkyl, (C₁-C₆)-alkoxy, (C₁-C₆)-haloalkoxy and phenyl, and where in each case two substituents at the nitrogen atom together can optionally form an unsubstituted or substituted ring, or
(v) a phosphonium ion, or
(vi) a sulfonium ion, or
(vii) an oxonium ion, or
(viii) a saturated or unsaturated/aromatic nitrogenous heterocyclic ionic compound which has 1-10 carbon atoms in a ring system and is optionally mono- or polycondensed and/or substituted by (C₁-C₄)-alkyl
and
b) one or more non-polar organic solvents selected from the group consisting of the C₆-C₁₆-aromatics mixtures
the Solvesso series (Exxon) and/or
the Caromax series (Carless), and also
optionally one or more further non-polar organic solvents.

2. The liquid formulation as claimed in claim 1 which comprises, as component b), in addition to the C₆-C₁₆-aromatic mixture, one or more of
mineral oils,
paraffins,
straight-chain or cyclic C₆-C₂₀-aliphatics, or
a mixture of two or more of said non-polar organic solvents.

3. The liquid formulation as claimed in claim 1 which comprises, as component b), a C₆-C₁₆-aromatic mixture of the Solvesso series (Exxon), the mixture comprising one or more of the types Solvesso 100, Solvesso 150 or Solvesso 200 or their naphthalene content-reduced types Solvesso 150 ND or Solvesso 200 ND, and/or a mixture which comprises at least two thereof.

4. The liquid formulation as claimed in claim 1 which comprises, as component b), a C₆-C₁₆-aromatic mixture of the Caromax series (Carless), the mixture comprising one or more of the types Caromax 28 and Caromax 28 LN and/or a mixture thereof.

5. The liquid formulation as claimed in claim 3, additionally comprising at least one of the components mentioned below:
c) one or more derivatives of polycarboxylic acids,
d) one or more agrochemicals different from the compound of formula (I), and/or one or more insecticides, fungicides, safeners, growth regulators and/or fertilizers,
e) customary auxiliaries and additives, or
f) tank mix components.

6. The liquid formulation as claimed in claim 5 which comprises, as additional component c), one or more compounds from the group of sulfosuccinates and/or the group of gemini surfactants.

7. The liquid formulation as claimed in claim 6 which comprises, as component c), one or more compounds from the group of sulfosuccinates according to formula (II): 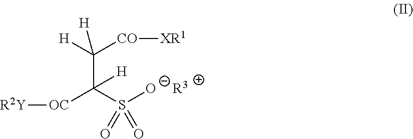
in which
R¹, R² independently of one another are identical or different and are H, substituted or unsubstituted C₁-C₃₀-hydrocarbon radicals,
R³ is a cation, and
X, Y independently of one another are identical or different and are O or NR⁴, where R⁴ is H, a substituted or unsubstituted C₁-C₃₀-hydrocarbon radical, or a (poly)alkylene oxide adduct.

8. The liquid formulation as claimed in claim 7 which comprises, as component c), a sodium dialkylsulfosuccinate.

9. The liquid formulation as claimed in claim 6 which comprises, as component c), one or more compounds from the group of gemini surfactants of formula (III) R⁵—CO-NA-R⁶—NB—CO—R⁷ or (IV) R⁶—O—CO—CH(SO³M)-R⁶—CH(SO³M)-CO—O—R⁷ in which
R⁵, R⁷ independently of one another are identical or different and are straight-chain, branched or cyclic saturated or unsaturated hydrocarbon radicals having 1 to 30 carbon atoms,
R⁶ is a spacer of a straight-chain or branched chain having 2 to 100 carbon atoms which contains 0 to 20 oxygen atoms, 0 to 4 sulfur atoms and/or 0 to 3 phosphorus atoms and which has 0 to 20 functional side groups, and which contains 0 to 100 alkoxy groups,
A, B independently of one another are identical or different and are polyalkylene oxide radicals having a terminal OH, C₁-C₂₀-alkyl, carboxyethyl, carboxymethyl, sulfonic acid, sulfuric acid, phosphoric acid or betaine grouping, and
M is a cation.

10. The liquid formulation as claimed in claim 5 which comprises, as component d), one or more herbicidally active compounds from the group of sulfonamides.

11. The liquid formulation as claimed in claim 10 which comprises, as component d), one or more phenylsulfonylureas or salts thereof.

12. The liquid formulation as claimed in claim 11 which comprises, as component d), at least one salt of iodosulfuron-methyl and/or salt of chlorsulfuron.

13. The liquid formulation as claimed in claim 5 which comprises, as component d), fenoxaprop-P-ethyl.

14. The liquid formulation as claimed in claim 5 which comprises, as component d), one or more safeners selected from the group consisting of:
mefenpyr,
fenchlorazole,
isoxadifen,
cloquintocet, and their C₁-C₁₀-alkyl esters
benoxacor and
cyprosulfamide.

15. The liquid formulation as claimed in claim 14 which comprises, as component d), one or more safeners selected from the group consisting of:
mefenpyr-diethyl,
fenchlorazole-ethyl,
isoxadifen-ethyl and
cloquintocet-mexyl.

16. The liquid formulation as claimed in claim 1 in the form of an emulsion concentrate (EC) or an oil dispersion (OD).

17. A process for preparing a formulation as claimed in claim 1 wherein the components are mixed and, if appropriate, ground.

18. A method for controlling unwanted vegetation wherein an effective amount of a liquid formulation as claimed in claim 1 is applied to plants, parts of plants, seed or and area on which plants grow.

19. A liquid herbicidal composition obtainable by diluting a liquid formulation as claimed in claim 1.
